(19) United States
(12) Patent Application Publication
(10) Pub. No.: US 2025/0383109 A1
(43) Pub. Date: Dec. 18, 2025

(54) FAN-SPEED CONTROL DEVICE WITH ADJUSTABLE PRESET SPEEDS

(71) Applicant: Lutron Technology Company LLC, Coopersburg, PA (US)

(72) Inventors: Edward J. Blair, Telford, PA (US); Benjamin M. Barcaskey, Auburndale, MA (US)

(73) Assignee: Lutron Technology Company LLC, Coopersburg, PA (US)

(21) Appl. No.: 19/237,827

(22) Filed: Jun. 13, 2025

Related U.S. Application Data
(60) Provisional application No. 63/659,470, filed on Jun. 13, 2024.

(51) Int. Cl. F24F 11/59; F24F 11/52; F24F 11/64; F24F 11/77; G06F 3/0482; G06F 3/04847

(52) U.S. Cl. CPC F24F 11/59; F24F 11/52; F24F 11/64; F24F 11/77; G06F 3/0482; G06F 3/04847

(57) ABSTRACT

A method for configuring a load control device configured to control a motor load may comprise receiving an indication of a selected preset speed to configure, receiving an indication of a selected possible speed to which to set the selected preset speed, and storing configuration data comprising the selected preset speed and the selected possible speed. The selected preset speed may be one of a number of discrete preset speeds to which the load control device can control a rotational speed of the motor load in response to receiving an input. The selected possible speed may be one of a number of discrete possible speeds to which a motor control circuit of the load control device can control the motor load. The configuration data may allow the load control device to control the motor load to the selected possible speed when the input indicates the selected preset speed.

### CROSS-REFERENCE TO RELATED APPLICATIONS

This application claims priority from Provisional U.S. Patent Application No. 63/659,470, filed Jun. 13, 2024, the entire disclosure of which is hereby incorporated by reference herein in its entirety.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and air-conditioning (HVAC) system may be used to control the temperature in the user environment. Each load control system may include various control devices, including control-source devices and control-target devices. The control-target devices may receive digital messages, which may include load control data, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motor control device (e.g., for a ceiling fan or exhaust fan), a motorized window treatment, a temperature control device (e.g., a thermostat), an AC plug-in load control device, and/or the like. Examples of control-source devices may include remote-control devices, occupancy sensors, daylight sensors, temperature sensors, and/or the like.

### SUMMARY

A method, an apparatus, and a system for configuring a load control device configured to control a motor load are described herein. The method may comprise receiving an indication of a selected preset speed to configure, receiving an indication of a selected possible speed to which to set the selected preset speed, and storing configuration data comprising the selected preset speed and the selected possible speed. The selected preset speed may be one of a number of discrete preset speeds to which the load control device can control a rotational speed of the motor load in response to receiving an input. The selected possible speed may be one of a number of discrete possible speeds to which a motor control circuit of the load control device can control the motor load. The configuration data may be configured to allow the load control device to control the motor load to the selected possible speed when the input indicates the selected preset speed.

In addition, as described herein, an apparatus for configuring a load control device may comprise a memory and a control circuit. The control circuit may be configured to receive an indication of a selected preset speed to configure, where the selected preset speed may be one of a number of discrete preset speeds to which a load control device can control a rotational speed of a motor load in response to receiving an input. The control circuit may be also configured to receive an indication of a selected possible speed to which to set the selected preset speed, where the selected possible speed may be one of a number of discrete possible speeds to which a motor control circuit of the load control device can control the motor load. The control circuit may be further configured to store configuration data comprising the selected preset speed and the selected possible speed in the memory, where the configuration data may be configured to allow the load control device to control the motor load to the selected possible speed when the input indicates the selected preset speed.

Further, the method and apparatus may include any combination of the following (e.g., even though it is described in view of a method). The method may include receiving the indication of the selected preset speed to configure further comprises receiving the indication of the selected preset speed using a graphical user interface displayed on a visible display, and receiving the indication of the selected possible speed to which to set the selected preset speed further comprises receiving the indication of the selected possible speed using the graphical user interface displayed on the visible display. The method may include displaying the discrete preset speeds on the visible display; and receiving a selection of one of the discrete preset speeds displayed on the visible display.

The method may include setting a low limit possible speed number and a high-limit possible speed number that together define a range of the discrete possible speeds to display on the visible display. The low limit possible speed number may be equal to a number of the selected preset speed, and the high-limit possible speed number may be equal to the number of the selected preset speed plus a difference between a number of discrete possible speeds and the number of the discrete preset speeds. The method may include determining that one of the preset speeds that is lower than the selected preset speed has been previously configured. The one of the preset speeds that is lower than the selected preset speed may be indicated by a lower preset speed number and may be set to one of the discrete possible speeds that is indicated by a lower possible speed number. Further, the low limit possible speed number may be equal to a lower possible speed number plus a difference between a number of the selected preset speed and the lower preset speed number. Further, the method may include determining that one of the preset speeds that is higher than the selected preset speed has been previously configured. The one of the preset speeds that is higher than the selected preset speed may be indicated by a higher preset speed number and may be set to one of the discrete possible speeds that is indicated by a higher possible speed number. Further, the high limit possible speed number may be equal to a higher possible speed number minus a difference between the higher preset speed number and a number of the selected preset speed.

The method may include limiting the number of the discrete possible speeds displayed on the visible display. The method may include limiting the number of the discrete possible speeds displayed on the visible display to ensure that the preset speeds increase in speed in order. The method may include limiting the number of the discrete possible speeds displayed on the visible display based on a prior selection of one of the discrete possible speeds for one of the other discrete preset speeds.

The method may include detecting a selection of an indicator of one of the discrete possible speeds in a pull-down menu. The method may include detecting an actuation of a selection object next to each of the discrete possible speeds displayed on the visible display. The method may include displaying the discrete possible speeds on the visible display in response to receiving the selection of one of the discrete preset speeds displayed on the visible display, and receiving a selection of one of the discrete possible speeds displayed on the visible display. The method may include receiving the selection of one of the discrete preset speeds in response to an actuation of an arrow actuator of a pull down menu.

The method may include receiving the input indicating the selected preset speed, and controlling the motor load to the selected possible speed in response to receiving an input indicating the selected preset speed. The method may include receiving the indication of the selected preset speed in one or more messages received via a communication circuit, and receiving the indication of the selected possible speed to which to set the selected preset speed further comprises receiving the indication of the selected possible speeds in one or more messages received via the communication circuit. The method may include storing the configuration data in memory at the load control device. The selected preset speed and the selected possible speed may be received in a single message. For example, the method may include receiving the indication of the selected preset speed in response to detecting a first actuation of a user interface of the load control device, and receiving the indication of the selected possible speed to which to set the selected preset speed further comprises receiving the indication of the selected possible speed in response to detecting a second actuation of the user interface of the load control device. The method may include storing the configuration data in memory at the load control device. The method may include entering an advanced programming mode prior to receiving the receiving the indication of the selected preset speed and receiving the indication of the selected possible speed. In some examples, the method may include detecting an actuation of a user interface of the load control device. Further, the method may include receiving a message comprising a command to control the motor load to the selected preset speed.

The method may include detecting an actuation via a slider selection tool using a graphical user interface displayed on a visible display. The method may include detecting an actuation of a preset speed indicator using a graphical user interface displayed on a visible display, and detecting release of the actuation of the preset speed indicator when the preset speed indicator is located at an indicator associated with the selected possible speed. The method may include displaying indicators associated with the discrete preset speeds and indicators associated with the discrete possible speeds along a linear guide using the graphical user interface displayed on the visible display. The preset speed indicator may be an indicator associated with a discrete preset speed, and the indicator associated with the selected possible speed may be an indicator associated with the discrete possible speeds. For example, when actuated, the preset speed indicator may be displayed larger than the other indicators associated with the discrete preset speeds. In some instances, the method may include limiting the ability of a user to associate the preset speed indicator with an indicator associated with a discrete possible speed. The discrete possible speed may be assigned to another one of the number of discrete preset speeds or may be associated with a speed that is outside of a range of the discrete possible speeds that are available for the preset speed indicator. The range may be based on a number associated with the preset speed indicator, a number of the discrete possible speeds, and/or a number of the discrete preset speeds.

The method may include greying out (e.g., as described below) the discrete possible speed to limit the ability of the user to associate the preset speed indicator with the indicator associated with the discrete possible speed. In some examples, the selected preset speed can only be configured to be set to one discrete possible speed at a time.

An apparatus may include a memory and a control circuit. The control circuit may be configured to receive an indication of a selected preset speed to configure, receive an indication of a selected possible speed to which to set the selected preset speed, and store configuration data comprising the selected preset speed and the selected possible speed in the memory. The selected preset speed may be one of a number of discrete preset speeds to which a load control device can control a rotational speed of a motor load in response to receiving an input. The selected possible speed may be one of a number of discrete possible speeds to which a motor control circuit of the load control device can control the motor load. The configuration data may be configured to allow the load control device to control the motor load to the selected possible speed when the input indicates the selected preset speed.

The control circuit may be configured to receive the indication of the selected preset speed using a graphical user interface displayed on a visible display, and receive the indication of the selected possible speed using the graphical user interface displayed on the visible display. The control circuit may be configured to display the discrete preset speeds on the visible display and receive a selection of one of the discrete preset speeds displayed on the visible display.

The control circuit may be configured to set a low limit possible speed number and a high-limit possible speed number that together define a range of the discrete possible speeds to display on the visible display. The low limit possible speed number may be equal to a number of the selected preset speed, and the high-limit possible speed number may be equal to the number of the selected preset speed plus a difference between a number of discrete possible speeds and the number of the discrete preset speeds. The control circuit may be configured to determine that one of the preset speeds that is lower than the selected preset speed has been previously configured. The one of the preset speeds that is lower than the selected preset speed may be indicated by a lower preset speed number and/or may be set to one of the discrete possible speeds that is indicated by a lower possible speed number. The low limit possible speed number may be equal to a lower possible speed number plus a difference between a number of the selected preset speed and the lower preset speed number.

The control circuit may be configured to determine that one of the preset speeds that is higher than the selected preset speed has been previously configured. The one of the preset speeds that is higher than the selected preset speed may be indicated by a higher preset speed number and/or may be set to one of the discrete possible speeds that is indicated by a higher possible speed number. The high limit possible speed number may be equal to a higher possible speed number minus a difference between the higher preset speed number and a number of the selected preset speed.

The control circuit may be configured to limit the number of the discrete possible speeds displayed on the visible display. The control circuit may be configured to limit the number of the discrete possible speeds displayed on the visible display to ensure that the preset speeds increase in speed in order.

The control circuit may be configured to limit the number of the discrete possible speeds displayed on the visible display based on a prior selection of one of the discrete possible speeds for one of the other discrete preset speeds.

The control circuit may be configured to detect a selection of an indicator of one of the discrete possible speeds in a pull-down menu. The control circuit may be configured to detect an actuation of a selection object next to each of the discrete possible speeds displayed on the visible display.

The control circuit may be configured to display the discrete possible speeds on the visible display in response to receiving the selection of one of the discrete preset speeds displayed on the visible display, and/or receive a selection of one of the discrete possible speeds displayed on the visible display. The control circuit may be configured to receive the selection of one of the discrete preset speeds in response to an actuation of an arrow actuator of a pull down menu.

The control circuit may be configured to receive the input indicating the selected preset speed, and/or control the motor load to the selected possible speed in response to receiving an input indicating the selected preset speed. The control circuit may be configured to receive the indication of the selected preset speed in one or more messages received via a communication circuit, and/or receive the indication of the selected possible speed to which to set the selected preset speed further comprises receiving the indication of the selected possible speeds in one or more messages received via the communication circuit. The control circuit may be configured to store the configuration data in memory at the load control device. The selected preset speed and the selected possible speed may be received in a single message. The control circuit may be configured to receive the indication of the selected preset speed in response to detecting a first actuation of a user interface of the load control device, and/or receive the indication of the selected possible speed to which to set the selected preset speed further comprises receiving the indication of the selected possible speed in response to detecting a second actuation of the user interface of the load control device.

The control circuit may be configured to store the configuration data in memory at the load control device. The control circuit may be configured to enter an advanced programming mode prior to receiving the receiving the indication of the selected preset speed and receiving the indication of the selected possible speed. The control circuit may be configured to detect an actuation of a user interface of the load control device. The control circuit may be configured to receive a message comprising a command to control the motor load to the selected preset speed.

The control circuit may be configured to detect an actuation via a slider selection tool using a graphical user interface displayed on a visible display. The control circuit may be configured to detect an actuation of a preset speed indicator using a graphical user interface displayed on a visible display, and/or detect release of the actuation of the preset speed indicator when the preset speed indicator is located at an indicator associated with the selected possible speed. The control circuit may be configured to display indicators associated with the discrete preset speeds and indicators associated with the discrete possible speeds along a linear guide using the graphical user interface displayed on the visible display. The preset speed indicator may be an indicator associated with a discrete preset speed. The indicator associated with the selected possible speed may be an indicator associated with the discrete possible speeds. In some examples, when actuated, the preset speed indicator may be displayed larger than the other indicators associated with the discrete preset speeds. The control circuit may be configured to limit the ability of a user to associate the preset speed indicator with an indicator associated with a discrete possible speed. The discrete possible speed may be assigned to another one of the number of discrete preset speeds or is associated with a speed that is outside of a range of the discrete possible speeds that are available for the preset speed indicator. The range may be based on a number associated with the preset speed indicator, a number of the discrete possible speeds, and a number of the discrete preset speeds. The control circuit may be configured to grey out the discrete possible speed to limit the ability of the user to associate the preset speed indicator with the indicator associated with the discrete possible speed. The selected preset speed may be (e.g., may only be) configured to be set to one discrete possible speed at a time.

A fan-speed control device for controlling a motor load is disclosed herein. The fan-speed control device may comprise a motor control circuit configured to control a rotational speed of the motor load to a number of discrete possible speeds, and a control circuit configured to control the motor control circuit to control the rotational speed of the motor load to one of a number of discrete preset speeds in response to receiving an input. The control circuit may be configured to receive an indication of a selected preset speed to configure, the selected preset speed being one of the number of discrete preset speeds, and receive an indication of a selected possible speed to which to set the selected preset speed, the selected possible speed being one of the number of discrete possible speeds. The control circuit may be further configured to control the motor load to the selected possible speed when the input indicates the selected preset speed.

The fan-speed control device may include a communication circuit configured to receive messages. The control circuit may be configured to receive the input in a first message via the communication circuit. The input may include a command to control the rotational speed of the motor to the selected preset speed. The control circuit may be configured to receive the selected preset speed and the selected possible speed in a second message via the communication circuit. The fan-speed control device may include a user interface configured to receive the input. The input may include an actuation of the user interface. The control circuit may be configured to receive the selected preset speed in response to a first actuation of the user interface and to receive the selected possible speed in a second actuation of the user interface. The fan-speed control device may include a memory for storing configuration data comprising the selected preset speed and the selected possible speed.

Further, a non-transitory computer readable storage medium that includes instructions that, when executed by one or more processors of a device, cause the one or more processor to perform one or more of the steps or procedures described herein. For example, the instructions may cause the one or more processors to receive an indication of a selected preset speed to configure, the selected preset speed being one of a number of discrete preset speeds to which the load control device can control a rotational speed of the motor load in response to receiving an input, receive an indication of a selected possible speed to which to set the selected preset speed, the selected possible speed being one of a number of discrete possible speeds to which a motor control circuit of the load control device can control the motor load, and store configuration data comprising the selected preset speed and the selected possible speed, the configuration data being configured to allow the load control device to control the motor load to the selected possible speed when the input indicates the selected preset speed.

A system controller for configuring a load control device configured to control a motor load may be described herein. The system controller may include a processor that is configured to receive an indication of a selected preset speed to configure, receive an indication of a selected possible speed to which to set the selected preset speed, and generate configuration data comprising the selected preset speed and the selected possible speed. The selected preset speed may be one of a number of discrete preset speeds to which the load control device can control a rotational speed of the motor load in response to receiving an input. The selected possible speed may be one of a number of discrete possible speeds to which a motor control circuit of the load control device can control the motor load. The configuration data may be configured to allow the load control device to control the motor load to the selected possible speed when the input indicates the selected preset speed.

The processor may be configured to cause a graphical user interface to be displayed on a visible display of a network device. The indication of the selected preset speed may be received via the graphical user interface, and the indication of the selected possible speed may be received via the graphical user interface. The processor may be configured to set a low limit possible speed number and a high-limit possible speed number that together define a range of the discrete possible speeds to display on the visible display. The low limit possible speed number may be equal to a number of the selected preset speed, and the high-limit possible speed number is equal to the number of the selected preset speed plus a difference between a number of discrete possible speeds and the number of the discrete preset speeds.

The processor may be configured to determine that one of the preset speeds that is lower than the selected preset speed has been previously configured. The one of the preset speeds that is lower than the selected preset speed may be indicated by a lower preset speed number and/or may be set to one of the discrete possible speeds that is indicated by a lower possible speed number. The low limit possible speed number may be equal to a lower possible speed number plus a difference between a number of the selected preset speed and the lower preset speed number.

The processor may be configured to determine that one of the preset speeds that is higher than the selected preset speed has been previously configured. The one of the preset speeds that is higher than the selected preset speed may be indicated by a higher preset speed number and/or may be set to one of the discrete possible speeds that is indicated by a higher possible speed number. The high limit possible speed number may be equal to a higher possible speed number minus a difference between the higher preset speed number and a number of the selected preset speed.

The processor may be configured to limit the number of the discrete possible speeds displayed on the visible display. The processor may be configured to limit the number of the discrete possible speeds displayed on the visible display to ensure that the preset speeds increase in speed in order. The processor may be configured to limit the number of the discrete possible speeds displayed on the visible display based on a prior selection of one of the discrete possible speeds for one of the other discrete preset speeds.

The processor may be configured to cause the discrete possible speeds to be displayed on the visible display in response to receiving the selection of one of the discrete preset speeds displayed on the visible display, and receive a selection of one of the discrete possible speeds from the network device. The processor may be configured to send, to the load control device, the configuration data comprising the selected preset speed and the selected possible speed.

### BRIEF DESCRIPTION OF THE DRAWINGS

FIG. 1 is a diagram of an example load control system for controlling the operation of an electrical device, such as a ceiling fan.

FIGS. 2A-2E illustrate an example screen (e.g., a graphical user interface window) that may be used to configure preset speeds of a fan-speed control device.

FIGS. 2F-2H illustrate another example screen (e.g., a graphical user interface window) that may be used to configure preset speeds of a fan-speed control device.

FIG. 3A is a perspective view of an example control device, such as a fan-speed control device for controlling a motor load, such as a motor of a ceiling fan.

FIG. 3B is a front view of the control device of FIG. 3A.

FIGS. 4A-4D are front views of a user interface of the control device of FIG. 3A that illustrate illumination on a light bar to indicate the first, second, third, or fourth speeds of the ceiling fan.

FIGS. 5A-5D are front views of a user interface of the control device of FIG. 3A that illustrate illumination on a light bar to indicate the first, second, third, or fourth speeds of the ceiling fan.

FIG. 6 shows a simplified block diagram of an example fan-speed control device.

FIG. 7 shows a simplified block diagram of an example processing device.

FIG. 8 is a flowchart of an example procedure that may be executed by a control device to configure a fan-speed control device.

FIG. 9 is a flowchart of an example procedure that may be executed by a processing device to configure a fan-speed control device using, for example, a graphical user interface.

FIG. 10 is a flowchart of an example procedure that may be executed by a control device to display possible speed options for configuring a preset speed of a fan-speed control device.

FIG. 11 is flowchart of an example procedure that may be executed by a fan-speed control device.

### DETAILED DESCRIPTION

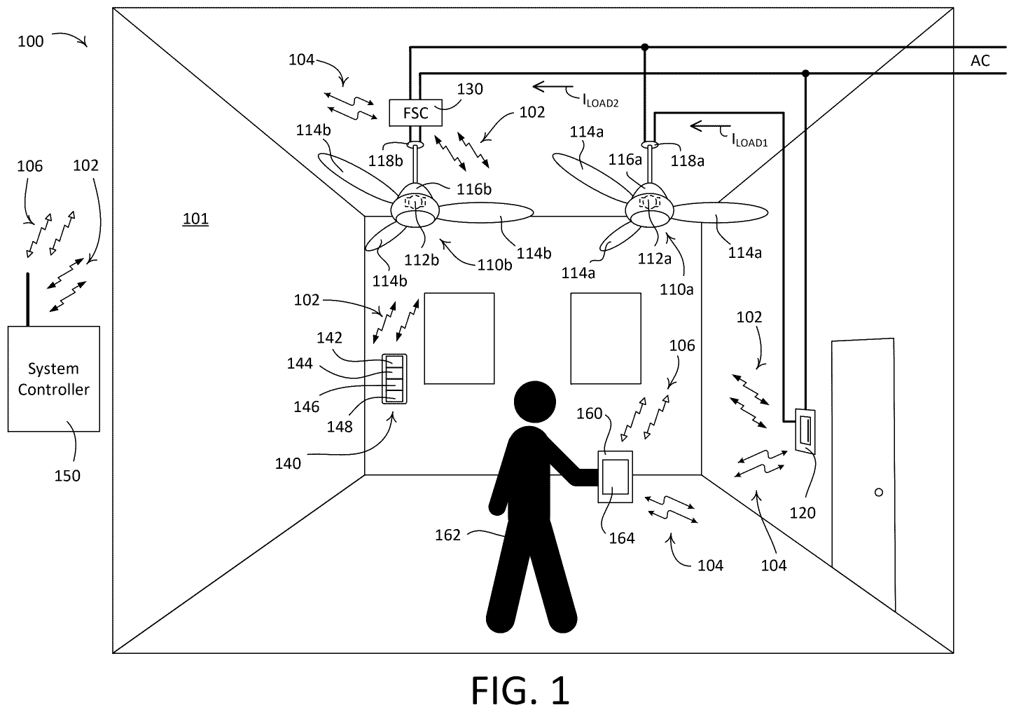

FIG. 1 is a diagram of an example load control system 100 for controlling the operation of one or more electrical devices, such as first and second ceiling fans 110a, 110b. The first and second ceiling fans 110a, 110b may each receive power from a power source, such as an alternating-current (AC) power source or a direct-current (DC) power source. The first and second ceiling fans 110a, 110b may be installed on the ceiling of a room 101 or space in a building. Each of the first and second ceiling fans 110a, 110b may comprise a respective motor load, such as first and second motors 112a, 112b (e.g., fan motors), for rotating a plurality of respective blades 114a, 114b to circulate the air in the room 101. For example, each of the first and second ceiling fans 110a, 110b may comprise three blades 114a, 114b as shown in FIG. 1. Each of the first and second ceiling fans 110a, 110b may also comprise a housing 116a, 116b for housing the motor 114a, 114b, respectively, and a base portion 118a, 118b for mounting the ceiling fan 110a, 110b, respectively, to the ceiling of the room 101.

The load control system 100 may also comprise one or more load control devices, such as a first fan-speed control device 120 for controlling the motor 112a of the first ceiling fan 110a and a second fan-speed control device 130 for controlling the motor 112b of the second ceiling fan 110b. The first fan-speed control device 120 may be electrically coupled in series between the power source and the first ceiling fan 110a and may be wall-mounted in an electrical wallbox. The first fan-speed control device 120 may comprise an internal motor control circuit configured to control the second ceiling fan 110a by controlling a load current I_{LOAD1} conducted through the motor 112a of the first ceiling fan 110a. The first fan-speed control device 120 may be configured to control the load current I_{LOAD1} to turn the first ceiling fan 110a on and off and/or to adjust a rotational speed S_{FAN1} of the first ceiling fan 110a. The first fan-speed control device 120 (e.g., the motor control circuit of the first fan-speed control device 120) may be configured to control the rotational speed S_{FAN1} of the first ceiling fan 110a to a total number N_{POS-TOT1} of possible speeds (e.g., discrete speeds), for example, one of seven discrete possible speeds S_{POS1-1}-S_{POS1-7} (e.g., one of the seven discrete possible speeds at a time). In addition, the first load control device 120 may be configured to adjust a direction of rotation of the first ceiling fan 110a. The first fan-speed control device 120 may comprise a user interface having one or more actuators for receiving user inputs for controlling the motor 112a of the first ceiling fan 110a and/or configured the first fan-speed control device 120. For example, the user interface of the first fan-speed control device 120 may comprise an on/off actuator for causing the ceiling fan 110a to be turned on and/or off, and a fan-speed adjustment actuator for causing the rotational speed S_{FAN1} of the first ceiling fan 110a to be adjusted. In addition, the first fan-speed control device 120 may be configured to adjust one or more configuration settings of the first fan-speed control device 120 in response to actuations of the actuators of the user interface.

The second fan-speed control device 130 may be electrically coupled in series between the power source and the second ceiling fan 110b, and may be mounted remotely, for example, to a junction box above a ceiling and/or behind a wall of the room 101. In some examples, the second fan-speed control device 130 may be housed in the base portion 118b of the second ceiling fan 110b. The second fan-speed control device 130 may comprise a motor control circuit configured to control the second ceiling fan 110b by controlling a load current I_{LOAD2} conducted through the motor 112b of the second ceiling fan 110b. For example, the second fan-speed control device 130 may be configured to control the load current I_{LOAD2} to turn the second ceiling fan 110b on and off and/or to adjust the rotational speed of the second ceiling fan 110b. The second fan-speed control device 130 (e.g., the motor control circuit of the second fan-speed control device 130) may be configured to control the rotational speed S_{FAN2} of the second ceiling fan 110b to a total number N_{POS-TOT2} of possible speeds (e.g., discrete speeds), for example, one of seven discrete possible speeds S_{POS2-1}-S_{POS2-7} (e.g., one of the seven discrete possible speeds at a time). In addition, the second fan-speed control device 130 may be configured to adjust a direction of rotation of the second ceiling fan 110b. The second fan-speed control device 130 may comprise a user interface having one or more actuators for receiving user inputs for controlling the motor 112b of the second ceiling fan 110b and/or for configuring the second fan-speed control device 130. For example, the user interface of the second fan-speed control device 130 may comprise a basic user interface (e.g., a one or more actuators and/or light sources) for controlling and/or configuring the second fan-speed control device 130.

The first fan-speed control device 120 and the second fan-speed control device 130 may be configured to communicate (e.g., transmit and receive) messages (e.g., digital message) via wired signals or wireless signals, such as radio-frequency (RF) signals 102, 104. For example, the first and second fan-speed control devices 120, 130 may be configured to control the first and second ceiling fans 110a, 110b, respectively, in response to control data (e.g., commands) received in the messages via the RF signals 102, 104. The first and second fan-speed control devices 120, 130 may each comprise one or more wireless communication circuits for transmitting and/or receiving messages via the RF signals 102, 104. A first wireless communication circuit of each of the first and second fan-speed control devices 120, 130 may be capable of communicating on a first wireless communication link (e.g., a wireless network communication link) and/or communicating using a first wireless protocol (e.g., a wireless network communication protocol, such as the CLEAR CONNECT protocol (e.g., the CLEAR CONNECT A and/or the CLEAR CONNECT X protocols) and/or the THREAD protocol) via the RF signals 102. A second wireless communication circuit of each of the first and second ceiling fans 110a, 110b may be capable of communicating on a second wireless communication link (e.g., a short-range wireless communication link) and/or communicating using a second wireless protocol (e.g., a short-range wireless communication protocol, such as the BLUETOOTH and/or BLUETOOTH LOW ENERGY (BLE) protocols) via the RF signals 104.

The load control system 100 may comprise a remote control device 140 (e.g., a remote fan-speed control device) for transmitting messages (e.g., digital message) including control information (e.g., commands) for controlling the first and second ceiling fans 110a, 110b via the RF signals 102. For example, the remote control device 140 may be battery-powered, and may be handheld, mounted to a wall, and/or mounted to a pedestal to be placed on a tabletop. The remote control device 140 may comprise a plurality of buttons (e.g., four buttons as shown in FIG. 1), such as, for example, a first button 142, a second button 144, a third button 146, and a fourth button 148. For example, the remote control device 140 may be configured to transmit the messages including the control data to the first and second fan-speed control devices 120, 130 for causing the first and second fan-speed control devices 120, 130 to control the first and second ceiling fans 110a, 110b, respectively, in response to actuations of one or more of the first button 142, the second button 144, the third button 146, and the fourth button 148. The first and second fan-speed control devices 120, 130 may be configured to turn on the first and second ceiling fans 110a, 110b, respectively, in response to actuations of the first button 142, and to turn off the first and second ceiling fans 110a, 110b, respectively, in response to actuations of the fourth button 148. The first and second fan-speed control devices 120, 130 may be configured to increase the rotational speed of the motors 112a, 112b of the first and second ceiling fans 110a, 110b, respectively, in response to actuations of the second button 144, and decrease the rotational speed of the motors 112a, 112b of the first and second ceiling fans 110a, 110b, respectively, in response to actuations of the third button 146. One will recognize that the control device of the first and second fan-speed control devices 120, 130 may also and/or alternatively be configured to receive control signals from a control device via a wired communication link. In some examples, the first button 142, the second button 144, the third button 146, and the fourth button 148 may be provided on the remote control device 140 in a different order. In addition, the remote control device 140 may comprise more or less buttons in some examples.

The load control system 100 may also comprise a system controller 150 that may be configured to transmit and/or receive messages via wired and/or wireless communications. For example, the system controller 150 may be configured to transmit and/or receive the RF signals 102, to communicate with one or more control devices of the load control system 100 (e.g., the first fan-speed control device 120, the second fan-speed control device 130, and/or the remote control device 140). The system controller 150 may be coupled to one or more wired control devices of the load control system 100 via a wired digital communication link. The system controller 150 may also, or alternatively, be capable of communicating on a third wireless communication link (e.g., a network communication link) and/or communicating using a third wireless protocol (e.g., a network communication protocol, such as Internet protocol, Ethernet-based protocols, WI-FI protocols, or other suitable network protocols), via RF signals 106. For example, the system controller 150 may be configured to transmit and/or receive messages on a network (e.g., a local area network and/or a wide area network, such as the Internet), via the RF signals 106. The system controller 150 may transmit messages to the first and second fan-speed control devices 120, 130 in response to messages received via the network. The messages may include configuration data for configuring the first and second fan-speed control devices 120, 130 and/or control data (e.g., commands) for controlling the first and second fan-speed control devices 120, 130. In some examples, the system controller 150 may be configured to transmit and receive messages between the control devices of the load control system 100. For example, the system controller 150 may transmit messages to the first and second fan-speed control devices 120, 130 for controlling the first and second ceiling fans 110a, 110b, respectively, in response to the messages received from the remote control device 140 (e.g., via the RF signals 102).

A network device 160 may be in communication with the first and second fan-speed control devices 120, 130 and/or the system controller 150 for configuring and/or controlling the control devices of the load control system 100. The network device 160 may comprise a wireless phone, a tablet, a laptop, a personal digital assistant (PDA), a wearable device (e.g., a watch, glasses, etc.), or other computing device. The network device 160 may be operated by a user 162. For example, the network device 160 may comprise a visible display 164 for displaying a graphical user interface (GUI) for displaying information for the user 162 and receiving inputs from the user 162. The network device 160 may be configured to communicate with the first and second fan-speed control devices 120, 130 via the RF signals 104 (e.g., using the short-range wireless communication protocol on the short-range wireless communication link). In addition, the network device 160 may be configured to communicate with the system controller 150 via the RF signals 106 (e.g., using the network communication protocol on the network communication link). Further, the network device 160 may be configured to transmit and/or receive beacon signals that may be used to commission the load control system 100 via the short-range wireless communication link (e.g., using the RF signals 104).

As previously mentioned, the first fan-speed control device 120 may be configured to control the rotational speed S_{FAN1} of the first ceiling fan 110a to seven discrete possible speeds S_{POS1-1}-S_{POS1-7}, and the second fan-speed control device 130 may be configured to control the rotational speed S_{FAN2} of the second ceiling fan 110b to seven discrete possible speeds S_{POS2-1}-S_{POS2-7}. However, a typical user of the first and second fan-speed control devices 120, 130 may not need to be able to adjust the rotational speed S_{FAN1} of the first ceiling fan 110a and the rotational speed S_{FAN2} of the second ceiling fan 110b across seven possible speeds (e.g., the user may not need that level of granularity of control). In some cases, providing too many options for setting the rotational speed S_{FAN1} of the first ceiling fan 110a and the rotational speed S_{FAN2} of the second ceiling fan 110b may become confusing to the user (e.g., since some of the possible speeds may not produce a visible and/or noticeable change in the rotational speeds S_{FAN1}, S_{FAN2} of the first and second ceiling fans 110a, 110b, respectively).

To provide less options for the rotational speed S_{FAN1} of the first ceiling fan 110a and/or the rotational speed S_{FAN2} of the second ceiling fan 110b, the first fan-speed control device 120 may be configured to allow the rotational speed S_{FAN1} of the first ceiling fan 110a to be adjusted (e.g., only adjusted) to a first subset of the possible speeds S_{POS1-1}-S_{POS1-7} of the first ceiling fan 110a and the second fan-speed control device 130 may be configured to allow the rotational speed S_{FAN2} of the second ceiling fan 110a to be adjusted (e.g., only adjusted) to a second subset of the possible speeds S_{POS2-1}-S_{POS2-7} of the second ceiling fan 110b. For example, the first fan-speed control device 120 may be configured to allow the rotational speed S_{FAN1} of the first ceiling fan 110a to be adjusted to a total number N_{PRE-TOT1} of preset speeds (e.g., discrete speeds), e.g., one of four discrete preset speeds S_{PRE1-1}-S_{PRE1-4} (e.g., one of the four discrete preset speeds at a time). In addition, the second fan-speed control device 130 may be configured to allow the rotational speed S_{FAN2} of the second ceiling fan 110b to be adjusted to a total number N_{PRE-TOT2} of preset speeds (e.g., discrete speeds), e.g., one of four discrete preset speeds S_{PRE2-1}-S_{PRE2-4} (e.g., one of the four discrete preset speeds at a time). The total number N_{PRE-TOT1} of the preset speeds S_{PRE1-1}-S_{PRE1-4} of the first ceiling fan 110a may be less than the total number N_{POS-TOT1} of the possible speeds S_{POS1-1}-S_{POS1-7} of the first ceiling fan 110a, and the total number N_{PRE-TOT2} of the preset speeds S_{PRE2-1}-S_{PRE2-4} of the second ceiling fan 110b may be less than the total number N_{POS-TOT2} of the possible speeds S_{POS2-1}-S_{POS2-7} of the second ceiling fan 110b. In some examples, each of the preset speeds S_{PRE1-1}-S_{PRE1-4} of the first fan-speed control device 120 may be set to (e.g., fixed equal to) a different one of the possible speeds S_{POS1-1}-S_{POS1-7}, and each of the preset speeds S_{PRE2-1}-S_{PRE2-4} of the second fan-speed control device 130 may be set to (e.g., fixed equal to) a different one of the possible speeds S_{POS2-1}-S_{POS2-7}.

In some examples, the first and second fan-speed control devices 120, 130 may be configured to select one of the preset speeds S_{PRE1-1}-S_{PRE1-4} and/or one of the preset speeds S_{PRE2-1}-S_{PRE2-4}, respectively, in response to an actuation of one of the buttons of the remote control device 140. For example, the first fan-speed control device 120 may be configured to control the rotational speed S_{FAN1} of the first ceiling fan 110a to the first preset speed S_{PRE1-1} in response to an actuation of the first button 142, to the second preset S_{PRE1-2} in response to an actuation of the second button 144, to the third preset S_{PRE1-3} in response to an actuation of the third button 146, and/or to the fourth preset S_{PRE1-4} in response to an actuation of the fourth button 148. In addition, the second fan-speed control device 130 may be configured to control the rotational speed S_{FAN2} of the second ceiling fan 110b to the first preset speed S_{PRE2-1} in response to an actuation of the first button 142, to the second preset S_{PRE2-2} in response to an actuation of the second button 144, to the third preset S_{PRE2-3} in response to an actuation of the third button 146, and/or to the fourth preset S_{PRE2-4} in response to an actuation of the fourth button 148. In some examples, the remote control device 140 may comprise one or more additional buttons for turning the first and second ceiling fans 110a, 110b on and/or off (e.g., in addition to selecting the preset speeds S_{PRE1-1}-S_{PRE1-4} of the first ceiling fan 110a and/or the preset speeds S_{PRE2-1}-S_{PRE2-4} of the second ceiling fan 110b).

Due to the interaction between the motor control circuits of the first and second fan-speed control devices 120, 130) and the motors 112a, 112b of the first and second ceiling fans 110a, 110b, respectively, the ceiling fans 110a, 110b may operate differently when controlled to the same one of the possible speeds S_{POS1-1}-S_{POS1-7} (e.g., due to variations in the motors, such as manufacturer, model, version, type, etc.). For example, when controlled to the fourth possible speed S_{POS1-4}, S_{POS2-4}, the first ceiling fan 110a may rotate at a relatively high speed (e.g., close to a maximum speed) and the second ceiling fan 110b may rotate at a relatively low speed (e.g., close to a minimum speed). In addition, when the each of the preset speeds S_{PRE1-1}-S_{PRE1-4} of the first fan-speed control device 120 and the preset speeds S_{PRE2-1}-S_{PRE2-4} of the second fan-speed control device 130 are fixed at one of the possible speeds S_{POS1-1}-S_{POS1-7} and one of the possible speeds S_{POS2-1}-S_{POS2-7}, respectively, the variation of the preset speeds S_{PRE1-1}-S_{PRE1-4} of the first fan-speed control device 120 and the preset speeds S_{PRE2-1}-S_{PRE2-4} of the second fan-speed control device 130 may be limited and/or unequally spaced apart. For example, two of the preset speeds S_{PRE1-1}-S_{PRE1-4} of the first fan-speed control device 120 may cause the first ceiling fan 110a to rotate at a relatively high speed (e.g., at relatively the same speed), while the other two of the preset speeds S_{PRE1-1}-S_{PRE1-4} may cause the first ceiling fan 110a to rotate at a relatively low speed (e.g., at relatively the same speed), such that there is a large gap in the range of the preset speeds S_{PRE1-1}-S_{PRE1-4} (e.g., a medium speed may not be achievable).

To provide for better control of the first and second ceiling fans 110a, 110b, the preset speeds S_{PRE1-1}-S_{PRE1-4} of the first fan-speed control device 120 and the preset speeds S_{PRE2-1}-S_{PRE2-4} of the second fan-speed control device 130 may be configurable (e.g., configurable by the user 162). For example, the first and second fan-speed control devices 120, 130 may be configured to set the preset speeds S_{PRE1-1}-S_{PRE1-4} and the preset speeds S_{PRE2-1}-S_{PRE2-4}, respectively, in response to inputs received via the respective user interface (e.g., from the user 162). In addition, the first and second fan-speed control devices 120, 130 may be configured to set the preset speeds S_{PRE1-1}-S_{PRE1-4} and the preset speeds S_{PRE2-1}-S_{PRE2-4}, respectively, in response to messages received from the system controller 150 and/or the network device 160 via the RF signals 102, 104. For example, the network device 160 may be configured to receive inputs from the user 162 via a graphical user interface (GUI) displayed on the visible display 164 and transmit one or more messages including configuration data to the first fan-speed control device 120 and/or the second fan-speed control device 130 (e.g., either directly and/or via the system controller 150). The user 162 may first select one of the preset speeds S_{PRE1-1}-S_{PRE1-4} of the first fan-speed control device 120 and/or the preset speeds S_{PRE2-1}-S_{PRE2-4} of the second fan-speed control device 130 to identify a selected preset speed S_{PRE-SEL} (e.g., via the user interface of the first fan-speed control device 120 or the second fan-speed control device 130 or the GUI displayed by the network device 160). The user 162 may then select one of the possible speeds S_{POS2-1}-S_{POS2-7} of the first fan-speed control device 120 or one of the possible speeds S_{POS2-1}-S_{POS2-7} of the second fan-speed control device 130 to assign to the selected preset speed S_{PRE-SEL} of the first fan-speed control device 120 or the second fan-speed control device 130, respectively, to identify a selected possible speed S_{POS-SEL}. The first fan-speed control device 120 and/or the second fan-speed control device 130 may be configured to save the selected possible speed S_{POS-SEL} as the selected preset speed S_{PRE-SEL} (e.g., in memory) to use when subsequently controlling the first ceiling fan 110a and/or the second ceiling fan 110b, respectively.

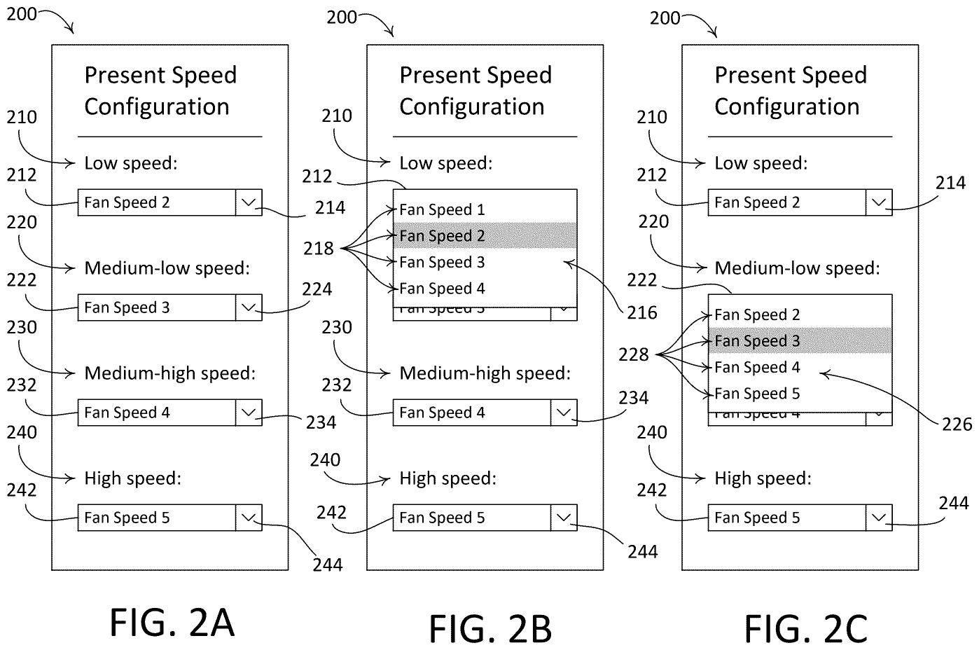

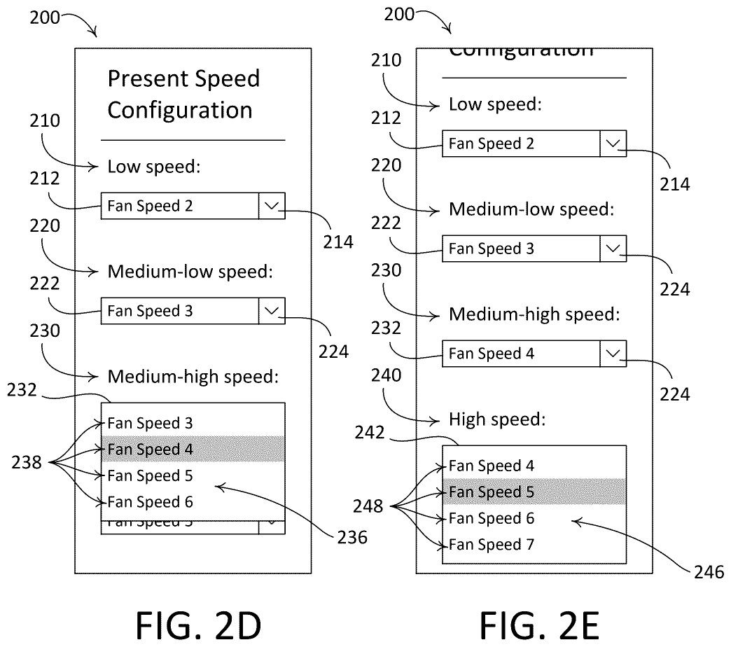

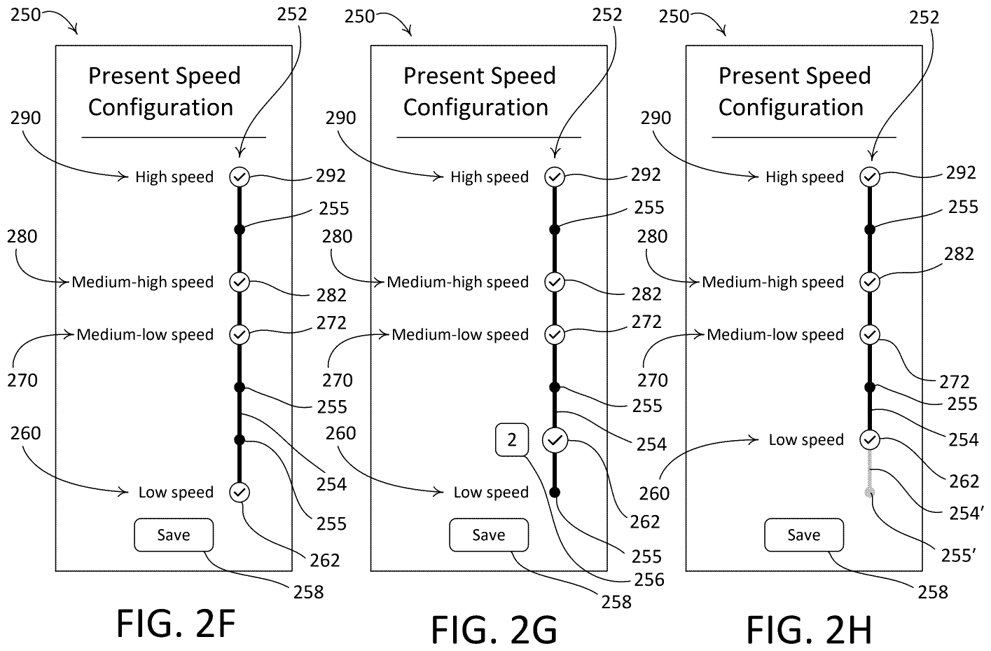

FIGS. 2A-2E illustrate an example screen 200 (e.g., a graphical user interface (GUI) window) that may be used to configure preset speeds S_{PRE1-1}-S_{PRE-4} of a fan-speed control device (e.g., the fan-speed control devices 120, 130). For example, the screen 200 may be displayed on a visible display of a network device (e.g., the visible display 164 of the network device 160). The screen 200 may be used to set each of a total number N_{PR}E-TOT of preset speeds S_{PRE-1}-S_{PRE-4} of the fan-speed control device to one of a total number N_{POS-TOT} of possible speeds S_{POS-1}-S_{POS-7}. For example, the first possible speed S_{POS-1} may be a minimum speed to which the ceiling fan may be controlled by the internal motor control circuit and the seventh possible speed S_{POS-7} may be a maximum speed to which the ceiling fan may be controlled by the internal motor control circuit (e.g., a full-on speed). The possible speeds S_{POS-1}-S_{POS-7} of the fan-speed control device may be ordered such that the second possible speed S_{POS-2} is faster than (e.g., greater than) the first possible speed S_{POS-1}, the third possible speed S_{POS-3} is faster than (e.g., greater than) the second possible speed S_{POS-2}, the fourth possible speed S_{POS-4} is faster than (e.g., greater than) the third possible speed S_{POS-3}, the fifth sixth possible speed S_{POS-6} is faster than (e.g., greater than) the fifth possible speed S_{POS-5}, and the seventh possible speed S_{POS-7} is faster than (e.g., greater than) the sixth possible speed S_{POS-6}.

Via the screen 200, the network device may receive a selection of one of the preset speeds S_{PRE-1}-S_{PRE-4} to be configured (e.g., a selected preset speed S_{PRE-SEL}) and one of the possible speeds S_{POS-1}-S_{POS-7} (e.g., a selected possible speed S_{POS-SEL}) to set to the selected preset speed S_{PRE-SEL}. As shown in FIG. 2A, the screen 200 may have a low preset speed selection portion 210 (e.g., for setting the first preset speed S_{PRE-1}), a medium-low preset speed selection portion 220 (e.g., for setting the second preset speed S_{PRE-2}), a medium-high preset speed selection portion 230 (e.g., for setting the third preset speed S_{PRE-3}), and a high preset speed selection portion 240 (e.g., for setting the fourth preset speed S_{PRE-4}). The preset speeds S_{PRE-1}-S_{PRE-4} of the fan-speed control device may be set using the screen 200, such that the preset speeds S_{PRE-1}-S_{PRE-4} increase in speed in order from the first preset speed S_{PRE-1} to the fourth preset speed S_{PRE-4}). For example, the second preset speed S_{PRE-2} is faster than (e.g., greater than) the first preset speed S_{PRE-1}, the third preset speed S_{PRE-3} is faster than (e.g., greater than) the second preset speed S_{PRE-2}, and the fourth preset speed S_{PRE-4} is faster than (e.g., greater than) the third preset speed S_{PRE-3}. As a result, the first preset speed S_{PRE-1} can only be set to the first possible speed S_{POS-1} through the fourth possible speed S_{POS-4}, the second preset speed S_{PRE-2} can only be set to the second possible speed S_{POS-2} through the fifth possible speed S_{POS-5}, the third preset speed S_{PRE-3} can only be set to the third possible speed S_{POS-3} through the sixth possible speed S_{POS-6}, and the fourth preset speed S_{PRE-4} can only be set to the fourth possible speed S_{POS-4} through the seventh possible speed S_{POS-7}. In addition, each of the possible speeds S_{POS-1}-S_{POS-7} may only be set to one of the preset speeds S_{PRE-1}-S_{PRE-4}. Accordingly, in some examples, the network device may be configured to limit which one of the possible speeds S_{POS-1}-S_{POS-7} may be selected as an option for a preset speed displayed in the low, medium-low, medium-high, and high preset speed selection portions 210, 220, 230, 240. Further, as another example, if the network device receives a selection of the fourth possible speed S_{POS-4} as the first preset speed S_{PRE-1}, the network device may be configured to auto-populate the medium-low, medium-high, and high preset speed selection portions 220, 230, 240 as the fifth, sixth, and seventh possible speeds S_{POS-5}, S_{POS-6}, S_{POS-7} (e.g., since the fifth, sixth, and seventh possible speeds S_{POS-5}, S_{POS-6}, S_{POS-7} must increase in speed relative to one another and there are only a total of seven possible speeds).

The low preset speed selection portion 210 may comprise a low preset speed pull-down menu 212 having an arrow actuator 214. When the arrow actuator 214 of the low preset speed pull-down menu 212 is actuated, the network device may display a possible speed selection list 216 on the screen 200 (e.g., as shown in FIG. 2B). The possible speed selection list 216 of the low preset speed pull-down menu 212 may include a plurality of possible speed indicators 218. The user may select one of the possible speed indicators 218 to indicate the one of the possible speeds to which to set the first preset speed S_{PRE-1}. For example, the possible speed selection list 216 of the low preset speed pull-down menu 212 may only include the possible speed indicators 218 for those of the possible speeds S_{POS1}-S_{POS7} that are available for the low preset speed (e.g., the possible speed indicators 218 may be displayed for the first possible speed S_{POS-1} through the fourth possible speed S_{POS-4}). The one of the possible speed indicators 218 that is presently selected may be highlighted as shown in FIG. 2B. When one of the possible speed indicators 218 is selected, the low preset speed pull-down menu 212 may close (e.g., the screen 200 may once again appear as shown FIG. 2A).

The network device may receive an indication that the first preset speed S_{PRE-1} has been selected (e.g., the selected preset speed S_{PRE-SEL}) in response to an actuation of the arrow actuator 214 of the low preset speed pull-down menu 212. The network device may receive an indication of a selection of one of the possible speeds (e.g., the selected possible speed S_{POS-SEL}) in response to a selection of one of the possible speed indicators 218 in the possible speed selection list 216. The network device may be configured to store configuration data (e.g., preset configuration data) representing the selected possible speed S_{POS-SEL} and the selected preset speed S_{PRE-SEL} (e.g., the first preset speed S_{PRE-1}) in memory (e.g., as a selected preset speed number N_{PRE-SEL} and a selected possible speed number N_{POS-SEL}, respectively). The network device may be configured to transmit the configuration data representing the selected preset speed S_{PRE-SEL} (e.g., the first preset speed S_{PRE-1}) and the selected possible speed S_{POS-SEL} to the fan-speed control device (e.g., directly and/or via a system controller, such as the system controller 150).

The medium-low preset speed selection portion 220 may comprise a medium-low preset speed pull-down menu 222 having an arrow actuator 224. When the arrow actuator 224 of the medium-low preset speed pull-down menu 222 is actuated, the network device may display a possible speed selection list 225 on the screen 200 (e.g., as shown in FIG. 2C). The possible speed selection list 226 of the medium-low preset speed pull-down menu 222 may include a plurality of possible speed indicators 228. The user may select one of the possible speed indicators 228 to indicate the one of the possible speeds to which to set the second preset speed S_{PRE-2}. For example, the possible speed selection list 226 of the medium-low preset speed pull-down menu 222 may only include the possible speed indicators 228 for those of the possible speeds S_{POS1}-S_{POS7} that are available for the medium-low preset speed (e.g., the possible speed indicators 228 may be displayed for the second possible speed S_{POS-2} through the fifth possible speed S_{POS-5}). The one of the possible speed indicators 228 that is presently selected may be highlighted as shown in FIG. 2C. When one of the possible speed indicators 228 is selected, the medium-low preset speed pull-down menu 222 may close (e.g., the screen 200 may once again appear as shown FIG. 2A).

The network device may receive an indication that the second preset speed S_{PRE-2} has been selected (e.g., the selected preset speed S_{PRE-SEL}) in response to an actuation of the arrow actuator 224 of the medium-low preset speed pull-down menu 222. The network device may receive an indication of a selection of one of the possible speeds (e.g., the selected possible speed S_{POS-SEL}) in response to a selection of one of the possible speed indicators 228 in the possible speed selection list 226. The network device may be configured to store configuration data (e.g., preset configuration data) representing the selected possible speed S_{POS-SEL} and the selected preset speed S_{PRE-SEL} (e.g., the second preset speed S_{PRE-2}) in memory (e.g., as a selected preset speed number N_{PRE-SEL} and a selected possible speed number N_{POS-SEL}, respectively). The network device may be configured to transmit the configuration data representing the selected preset speed S_{PRE-SEL} (e.g., the second preset speed S_{PRE-2}) and the selected possible speed S_{POS-SEL} to the fan-speed control device (e.g., directly and/or via a system controller, such as the system controller 150).

The medium-high preset speed selection portion 230 may comprise a medium-high preset speed pull-down menu 232 having an arrow actuator 234. When the arrow actuator 234 of the medium-high preset speed pull-down menu 232 is actuated, the network device may display a possible speed selection list 235 on the screen 200 (e.g., as shown in FIG. 2D). The possible speed selection list 236 of the medium-high preset speed pull-down menu 232 may include a plurality of possible speed indicators 238. The user may select one of the possible speed indicators 238 to indicate the one of the possible speeds to which to set the third preset speed S_{PRE-3}. For example, the possible speed selection list 236 of the medium-high preset speed pull-down menu 232 may only include the possible speed indicators 238 for those of the possible speeds S_{POS1}-S_{POS7} that are available for the medium-high preset speed (e.g., the possible speed indicators 238 may be displayed for the third possible speed S_{POS-3} through the sixth possible speed S_{POS-6}). The one of the possible speed indicators 238 that is presently selected may be highlighted as shown in FIG. 2D. When one of the possible speed indicators 238 is selected, the medium-high preset speed pull-down menu 232 may close (e.g., the screen 200 may once again appear as shown FIG. 2A).

The network device may receive an indication that the third preset speed S_{PRE-3} has been selected (e.g., the selected preset speed S_{PRE-SEL}) in response to an actuation of the arrow actuator 234 of the medium-high preset speed pull-down menu 232. The network device may receive an indication of a selection of one of the possible speeds (e.g., the selected possible speed S_{POS-SEL}) in response to a selection of one of the possible speed indicators 238 in the possible speed selection list 236. The network device may be configured to store configuration data (e.g., preset configuration data) representing the selected possible speed S_{POS-SEL} and the selected preset speed S_{PRE-SEL} (e.g., the third preset speed S_{PRE-3}) in memory (e.g., as a selected preset speed number N_{PRE-SEL} and a selected possible speed number N_{POS-SEL}, respectively). The network device may be configured to transmit the configuration data representing the selected preset speed S_{PRE-SEL} (e.g., the third preset speed S_{PRE-3}) and the selected possible speed S_{POS-SEL} to the fan-speed control device (e.g., directly and/or via a system controller, such as the system controller 150).

The high preset speed selection portion 240 may comprise a high preset speed pull-down menu 242 having an arrow actuator 244. When the arrow actuator 244 of the high preset speed pull-down menu 242 is actuated, the network device may display a possible speed selection list 245 on the screen 200 (e.g., as shown in FIG. 2E). The possible speed selection list 246 of the high preset speed pull-down menu 242 may include a plurality of possible speed indicators 248. The user may select one of the possible speed indicators 248 to indicate the one of the possible speeds to which to set the fourth preset speed S_{PRE-4}. For example, the possible speed selection list 246 of the high preset speed pull-down menu 242 may only include the possible speed indicators 248 for those of the possible speeds S_{POS1}-S_{POS7} that are available for the high preset speed (e.g., the possible speed indicators 248 may be displayed for the fourth possible speed S_{POS-4} through the seventh possible speed S_{POS-7}). The one of the possible speed indicators 248 that is presently selected may be highlighted as shown in FIG. 2E. When one of the possible speed indicators 248 is selected, the high preset speed pull-down menu 242 may close (e.g., the screen 200 may once again appear as shown FIG. 2A).

The network device may receive an indication that the fourth preset speed S_{PRE-4} has been selected (e.g., the selected preset speed S_{PRE-SEL}) in response to an actuation of the arrow actuator 244 of the high preset speed pull-down menu 242. The network device may receive an indication of a selection of one of the possible speeds (e.g., the selected possible speed S_{POS-SEL}) in response to a selection of one of the possible speed indicators 248 in the possible speed selection list 246. The network device may be configured to store configuration data (e.g., preset configuration data) representing the selected possible speed S_{POS-SEL} and the selected preset speed S_{PRE-SEL} (e.g., the fourth preset speed S_{PRE-4}) in memory (e.g., as a selected preset speed number N_{PRE-SEL} and a selected possible speed number N_{POS-SEL}, respectively). The network device may be configured to transmit the configuration data representing the selected preset speed S_{PRE-SEL} (e.g., the fourth preset speed S_{PRE-4}) and the selected possible speed S_{POS-SEL} to the fan-speed control device (e.g., directly and/or via a system controller, such as the system controller 150).

The network device may be configured to limit the possible speed indicators 218, 228, 238, 248 that are provided (e.g., displayed) in each of the respective possible speed selection lists 216, 226, 236, 246 for the selected preset speed S_{PRE-SEL}. As previously mentioned, the preset speeds S_{PRE-1}-S_{PRE-4} of the fan-speed control device may be ordered (e.g., may increase in speed in order), such that the second preset speed S_{PRE-2} is faster than (e.g., greater than) the first preset speed S_{PRE-1}, the third preset speed S_{PRE-3} is faster than (e.g., greater than) the second preset speed S_{PRE-2}, and the fourth preset speed S_{PRE-4} is faster than (e.g., greater than) the third preset speed S_{PRE-3}. In addition, each of the possible speeds S_{POS-1}-S_{POS-7} may only be set to one of the preset speeds S_{PRE-1}-S_{PRE-4} (e.g., each of the possible speeds S_{POS-1}-S_{POS-7} may not be assigned to two or more of the preset speeds S_{PRE-1}-S_{PRE-4}). The network device may be configured to display the possible speed indicators 218, 228, 238, 248 for the selected preset speed S_{PRE-SEL} to a range of the possible speeds S_{POS-1}-S_{POS-7} that may start at a low-limit possible speed number N_{LO-LMT} and end at a high-limit possible speed number N_{HI-LMT}.

When none of the preset speeds S_{PRE-1}-S_{PRE-4} have been configured (e.g., have been set to any of the possible speeds S_{POS-1}-S_{POS-7}), the network device may be configured to limit the possible speed indicators 218, 228, 238, 248 that are displayed to a maximum range of the possible speeds S_{POS-1}-S_{POS-7} for the selected preset speed S_{PRE-SEL}. The low-limit possible speed number N_{LO-LMT} and the high-limit possible speed number N_{HI-LMT} for the maximum range may be functions of, for example, the selected preset speed number N_{PRE-SEL} as well as the total number N_{PRE-TOT} of the preset speeds S_{POS-1}-S_{POS-7} and the total number N_{POS-TOT} of the possible speeds S_{POS-1}-S_{POS-7}. For example, the network device may be configured to set the low-limit possible speed number N_{LO-LMT} equal to the selected preset speed number N_{PRE-SEL}, and the high-limit possible speed number N_{HI-LMT} equal to the selected preset speed number N_{PRE-SEL} plus the difference between the total number N_{POS-TOT} of the possible speeds S_{POS-1}-S_{POS-7} and the total number N_{PRE-TOT} of the preset speeds S_{PRE-1}-S_{PRE-4}, e.g.,

$${N}_{HI - LMT} = {N}_{PRE - SEL} + ( {N}_{POS - TOT} - {N}_{PRE - TOT} ) .$$

The network device may display the possible speed indicators 218, 228, 238, 248 for those of the possible speeds S_{POS-1}-S_{POS-7} between the low-limit possible speed number N_{LO-LMT} and the high-limit possible speed number N_{HI-LMT}.

In addition, the network device may be configured to limit the possible speed indicators 218, 228, 238, 248 that are displayed based on any of the possible speeds S_{POS-1}-S_{POS-7} that are assigned to any of the other preset speeds S_{PRE-1}-S_{PRE-4}. For example, when the selected preset speed S_{PRE-SEL} is the second preset speed S_{PRE-2}, the maximum range of possible speeds S_{POS-1}-S_{POS-7} have start at the second possible speed S_{POS-2} and end at the fifth possible speed S_{POS-5}. However, if the third preset speed S_{PRE-3} has been previously set to the fourth possible speed S_{POS-4}, the network device may be configured to display the possible speed indicators 228 for only the second possible speed S_{POS-2} and the third possible speed S_{POS-3}. When any of the preset speeds that are lower than the selected preset speed S_{PRE-SEL} have already been configured, the network device may be configured to set the low-limit possible speed number N_{LO-LMT} based on the preset speed that is closest to the selected preset speed S_{PRE-SEL} below the selected preset speed S_{PRE-SEL} (e.g., that may be represented by a lower preset speed number N_{PRE-LO}) and the possible speed to which that preset speed is set (e.g., that may be represented by a lower possible speed number N_{POS-LO}). For example, the network device may be configured to set the low-limit possible speed number N_{LO-LMT} equal to the lower possible speed number N_{POS-LO} plus the difference between the selected preset speed S_{PRE-SEL} and the lower preset speed number N_{PRE-LO}, e.g.,

$${N}_{LO - LMT} = {N}_{POS - LO} + ( {N}_{PRE - SEL} - {N}_{PRE - LO} ) .$$

When any of the preset speeds that are higher than the selected preset speed S_{PRE-SEL} have already been configured, the network device may be configured to set the high-limit possible speed number N_{HI-LMT} based on the preset speed that is closest to the selected preset speed S_{PRE-SEL} above the selected preset speed S_{PRE-SEL} (e.g., that may be represented by a higher preset speed number N_{PRE-HI}) and the possible speed to which that preset speed is set (e.g., that may be represented by a higher possible speed number N_{POS-HI}). For example, the network device may be configured to set the high-limit possible speed number N_{HI-LMT} equal to the higher possible speed number N_{POS-HI} minus the difference between the higher preset speed number N_{PRE-HI} and the selected preset speed S_{PRE-SEL}, e.g.

$${N}_{HI - LMT} = {N}_{POS - HI} - ( {N}_{PRE - HI} - {N}_{PRE - SEL} ) .$$

The network device may display the possible speed indicators 218, 228, 238, 248 for those of the possible speeds S_{POS-1}-S_{POS-7} between the low-limit possible speed number N_{LO-LMT} and the high-limit possible speed number N_{HI-LMT}.

While FIGS. 2A-2E show the possible speed selection lists 216, 226, 236, 246 displayed as part of the various pull-down menus (e.g., the low preset speed pull-down menu 212, the medium-low preset speed pull-down menu 222, the medium-high preset speed pull-down menu 232, and the high preset speed pull-down menu 242), the possible speed selection lists 216, 226, 236, 246 could also simply be displayed as a list on the screen 200 in each of the low preset speed selection portion 210, the medium-low preset speed selection portion 220, the medium-high preset speed selection portion 230, and the high preset speed selection portion 240 (e.g., without the use of pull-down menus). For example, each of the possible speed selection lists 216, 226, 236, 246 may include a selection object next to each of the possible speed indicators 218, 228, 238, 248, where the selection objects may comprise checkboxes, radio buttons, or switches. The network device may be configured to allow only one of the possible speed indicators 218, 228, 238, 248 of each of the possible speed selection lists 216, 226, 236, 246 to be selected at one time.

FIGS. 2F-2H illustrate another example screen 250 (e.g., a GUI window) that may be used to configure preset speeds S_{PRE-1}-S_{PRE-4} of a fan-speed control device (e.g., the fan-speed control devices 120, 130). For example, the screen 250 may be displayed on a visible display of a network device (e.g., the visible display 164 of the network device 160). The screen 250 may be used to set each of a total number N_{PRE-TOT} of preset speeds S_{PRE-1}-S_{PRE-4} of the fan-speed control device to one of a total number N_{POS-TOT} of possible speeds S_{POS-1}-S_{POS-7}. For example, the first possible speed S_{POS-1} may be a minimum speed to which the ceiling fan may be controlled by the internal motor control circuit and the seventh possible speed S_{POS-7} may be a maximum speed to which the ceiling fan may be controlled by the internal motor control circuit (e.g., a full-on speed). The possible speeds S_{POS-1}-S_{POS-7} of the fan-speed control device may be ordered such that the second possible speed S_{POS-2} is faster than (e.g., greater than) the first possible speed S_{POS-1}, the third possible speed S_{POS-3} is faster than (e.g., greater than) the second possible speed S_{POS-2}, the fourth possible speed S_{POS-4} is faster than (e.g., greater than) the third possible speed S_{POS-3}, the fifth sixth possible speed S_{POS-6} is faster than (e.g., greater than) the fifth possible speed S_{POS-5}, and the seventh possible speed S_{POS-7} is faster than (e.g., greater than) the sixth possible speed S_{POS-6}.

Via the screen 250, the network device may receive a selection of one of the preset speeds S_{PRE-1}-S_{PRE-4} to be configured (e.g., a selected preset speed S_{PRE-SEL}) and one of the possible speeds S_{POS-1}-S_{POS-7} (e.g., a selected possible speed S_{POS-SEL}) to set to the selected preset speed S_{PRE-SEL}. As shown in FIG. 2F, the screen 250 may have a low preset speed selection portion 260 including a low preset speed indicator 262 for setting the first preset speed S_{PRE-1}, a medium-low preset speed selection portion 270 including a medium-low preset speed indicator 272 for setting the second preset speed S_{PRE-2}, a medium-high preset speed selection portion 280 including a medium-high preset speed indicator 282 for setting the third preset speed S_{PRE-3}, and a high preset speed selection portion 290 including a high preset speed indicator 292 for setting the fourth preset speed S_{PRE-4}. The preset speeds S_{PRE-1}-S_{PRE-4} of the fan-speed control device may be set using the screen 250, such that the preset speeds S_{PRE-1}-S_{PRE-4} increase in speed in order from the first preset speed S_{PRE-1} to the fourth preset speed S_{PRE-4}. For example, the second preset speed S_{PRE-2} is faster than (e.g., greater than) the first preset speed S_{PRE-1}, the third preset speed S_{PRE-3} is faster than (e.g., greater than) the second preset speed S_{PRE-2}, and the fourth preset speed S_{PRE-4} is faster than (e.g., greater than) the third preset speed S_{PRE-3}. As a result, the first preset speed S_{PRE-1} can only be set to the first possible speed S_{POS-1} through the fourth possible speed S_{POS-4}, the second preset speed S_{PRE-2} can only be set to the second possible speed S_{POS-2} through the fifth possible speed S_{POS-5}, the third preset speed S_{PRE-3} can only be set to the third possible speed S_{POS-3} through the sixth possible speed S_{POS-6}, and the fourth preset speed S_{PRE-4} can only be set to the fourth possible speed S_{POS-4} through the seventh possible speed S_{POS-7}. In addition, each of the possible speeds S_{POS-1}-S_{POS-7} may only be set to one of the preset speeds S_{PRE-1}-S_{PRE-4}.

The screen 250 may display a slider selection tool 252, which may comprise a linear guide 254 (e.g., a line) along which a number (e.g., seven) of possible speed indicators 255 are located. Each of the possible speed indicators 255 may indicate one of the total number N_{POS-TOT} of possible speeds S_{POS-1}-S_{POS-7}. For example, the possible speed indicators 255 may each comprise a circle (e.g., a dot) and may be equally-spaced along the linear guide 254. The preset speed indicators (e.g., the low preset speed indicator 262, the medium-low preset speed indicator 272, the medium-high preset speed indicator 282, and/or the high preset speed indicator 292) may each be located over top of one of the possible speed indicators 255 of the slider selection tool 252 (e.g., such that all of the seven possible speed indicators 255 are not visible in FIGS. 2F-2H). The low preset speed indicator 262, the medium-low preset speed indicator 272, the medium-high preset speed indicator 282, and/or the high preset speed indicator 292 may each be located on one of the possible speed indicators 255 to set the respective one of the preset speeds S_{PRE-1}-S_{PRE-4} equal to the respective one of the possible speeds S_{POS-1}-S_{POS-7}. For example, as shown in FIG. 2F, the low preset speed indicator 262 may be located on the first (e.g., lowest) possible speed indicator 255 to set the first preset speed S_{PRE-1} equal to the first possible speed S_{POS-1}; the medium-low preset speed indicator 272 may be located on the fourth possible speed indicator 255 to set the second preset speed S_{PRE-2} equal to the fourth possible speed S_{POS-4}; the medium-high preset speed indicator 282 may be located on the fifth possible speed indicator 255 to set the third preset speed S_{PRE-3} equal to the fifth possible speed S_{POS-5}; and the high preset speed indicator 292 may be located on the seventh possible speed indicator 255 to set the fourth preset speed S_{PRE-4} equal to the seventh possible speed S_{POS-7}.

The network device may receive a selection of one of the preset speeds S_{PRE-1}-S_{PRE-4} to be configured (e.g., a selected preset speed S_{PRE-SEL}) in response to an actuation of one of the low preset speed indicator 262, the medium-low preset speed indicator 272, the medium-high preset speed indicator 282, and/or the high preset speed indicator 292, respectively. A user may, for example, press and hold one of the low preset speed indicator 262, the medium-low preset speed indicator 272, the medium-high preset speed indicator 282, and/or the high preset speed indicator 292 on the visible display to select the respective preset speed S_{PRE-1}-S_{PRE-4} to configure. For example, the network device may receive an indication that the first preset speed S_{PRE-1} has been selected in response to an actuation (e.g., a press and hold) of the low preset speed indicator 262, an indication that the second preset speed S_{PRE-2} has been selected in response to an actuation (e.g., a press and hold) of the medium-low preset speed indicator 272, an indication that the third preset speed S_{PRE-3} has been selected in response to an actuation (e.g., a press and hold) of the medium-high preset speed indicator 282, and an indication that the fourth preset speed S_{PRE-4} has been selected in response to an actuation (e.g., a press and hold) of the high preset speed indicator 292.

While the user is pressing and holding one of the preset speed indicators, the user may move the selected preset speed indicator over one of the possible speed indicators 255 and cease the actuation of the respective preset speed indicator to select the respective possible speed S_{POS-1}-S_{POS-7} to assign to the respective preset speed S_{PRE-1}-S_{PRE-4} of the selected preset speed indicator. The network device may receive an indication of the selection of one of the possible speeds (e.g., the selected possible speed S_{POS-SEL}) in response to one of the preset speed indicators (e.g., the low preset speed indicator 262, the medium-low preset speed indicator 272, the medium-high preset speed indicator 282, and/or the high preset speed indicator 292) being located over one of the possible speed indicators 255 of the slider selection tool 252. As shown by FIGS. 2F and 2G (e.g., as shown by the transition from FIG. 2F to FIG. 2G), the user may press and hold the low preset speed indicator 262 to select the first preset speed S_{PRE-1} to configure and may slide the low preset speed indicator 262 over the second possible speed indicator 255 (e.g., while still pressing and holding the low preset speed indicator 262) to select the second possible speed S_{POS-2} to assign to the first preset speed S_{PRE-1}. While the user is presently selecting one of the preset speeds S_{PRE-1}-S_{PRE-4} to configure (e.g., while pressing and holding the respective preset speed indicator), the network device may cause the respective preset speed indicator to get slightly larger on the screen 250 to indicate that the respective preset speed S_{PRE-1}-S_{PRE-4} (e.g., as shown with the low preset speed indicator 262 in FIG. 2G). In addition, and in some examples, while the user is presently selecting one of the preset speeds S_{PRE-1}-S_{PRE-4} to configure (e.g., while pressing and holding the respective preset speed indicator), the network device may display a possible speed indicator bubble 256 on the screen 250 (e.g., as shown in FIG. 2G) that may include an indication of (e.g., a number indicating) the one of the possible speeds S_{POS-1}-S_{POS-7} that has been selected.

When the user ceases actuation of the selected preset speed indicator, the network device may be configured to store configuration data (e.g., preset configuration data) representing the selected preset speed S_{PRE-SEL} (e.g., of the selected preset speed indicator) and the selected possible speed S_{POS-SEL} (e.g., of the selected possible speed indicator 255) in memory (e.g., as a selected preset speed number N_{PRE-SEL} and a selected possible speed number N_{POS-SEL}, respectively). After the user ceases actuation of the selected preset speed indicator, the network device may gray out a portion of the linear guide 254 and/or one or more of the possible speed indicators 255 on the display 250 to indicate that the fan-speed control device may not be configured to control the rotational speed of the ceiling fan to those speeds during normal operation of the ceiling fan. For example, as shown in FIG. 2H, a lower portion 254′ and the first possible speed indicator 255′ may be grayed out after the low preset speed indicator 262 is located over the second possible speed indicator 255 (e.g., to indicate that the user cannot configure the medium-low, medium-high, or high speed indicators to the first possible speed indicator 255′). When the user has configured the preset speeds S_{PRE-1}-S_{PRE-4}, the user may actuate a save button 258 on the display 250 to cause the network device to transmit the configuration data representing the selected possible speeds S_{POS-1}-S_{POS-7} of the respective configured preset speeds S_{PRE-1}-S_{PRE-4} to the fan-speed control device (e.g., directly and/or via a system controller, such as the system controller 150).

The network device may be configured to limit movement of the preset speed indicators (e.g., the low preset speed indicator 262, the medium-low preset speed indicator 272, the medium-high preset speed indicator 282, and/or the high preset speed indicator 292) along the linear guide 254 of the slider selection tool 252 to maintain the preset speeds S_{PRE-1}-S_{PRE-4} of the fan-speed control device in order (e.g., increasing in order), such that the second preset speed S_{PRE-2} is faster than (e.g., greater than) the first preset speed S_{PRE-1}, the third preset speed S_{PRE-3} is faster than (e.g., greater than) the second preset speed S_{PRE-2}, and the fourth preset speed S_{PRE-4} is faster than (e.g., greater than) the third preset speed S_{PRE-3}. For example, the network device may be configured to prevent one of the preset speed indicators from crossing over another one of the preset speed indicators along the linear guide 254 of the slider selection tool 252, such that the preset speeds S_{PRE-1}-S_{PRE-4} of the fan-speed control device remain in order (e.g., increasing in order). In addition, two of the preset speed indicators may not be located over the same one of the possible speed indicators 255, such that each of the possible speeds S_{POS-1}-S_{POS-7} may only be set to one of the preset speeds S_{PRE-1}-S_{PRE-4} (e.g., one of the possible speeds S_{POS-1}-S_{POS-7} may not be assigned to two or more of the preset speeds S_{PRE-1}-S_{PRE-4}).

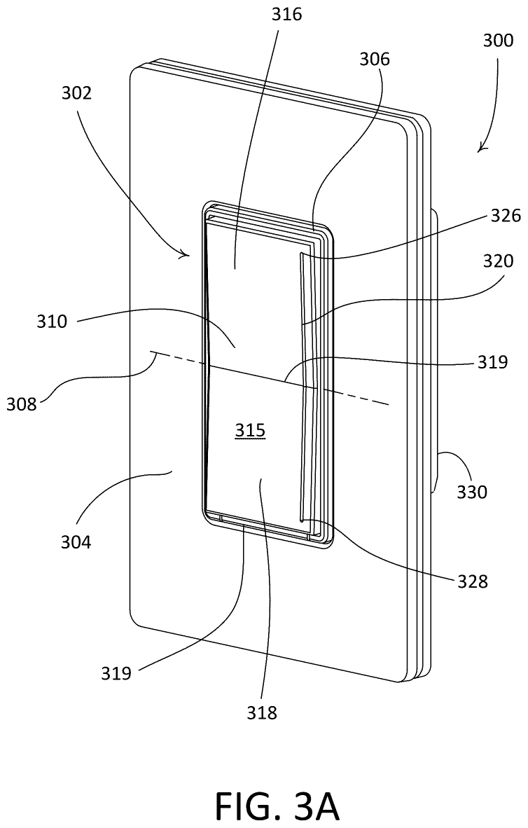

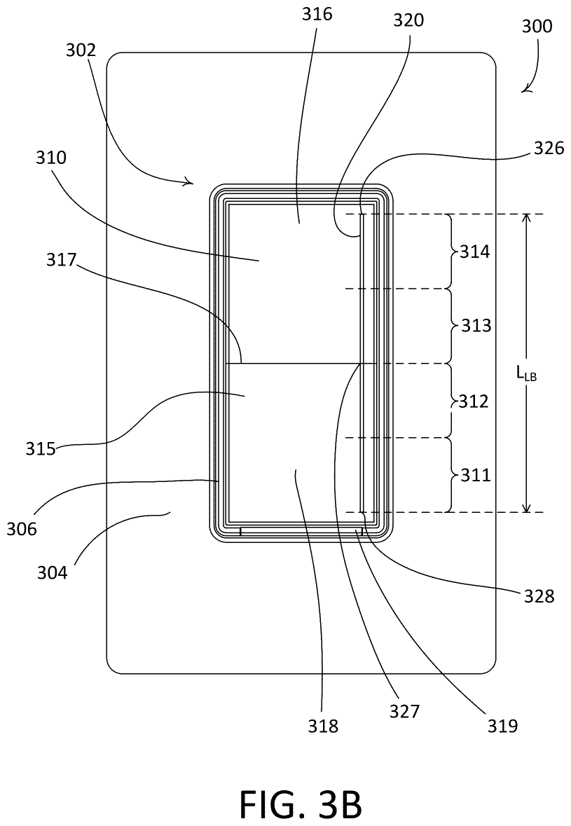

FIG. 3A-5D depict an example fan-speed control device 300 for controlling a ceiling fan (e.g., the first ceiling fan 110a, and/or the second ceiling fan 110b shown in FIG. 1). FIG. 3A is a perspective view and FIG. 3B is a front view of the example fan-speed control device 300. The fan-speed control device 300 may comprise a user interface 302 and a faceplate 304. The fan-speed control device 300 may be configured to turn the ceiling fan on and off and/or to control a rotational speed S_{FAN} of the ceiling fan in response to user inputs received via the user interface 302. The fan-speed control device 300 may comprise a communication circuit (e.g., a wireless communication circuit) configured to communication (e.g., transmit and receive) messages via signals (e.g., wireless signals, such the RF signals 102, 104). The fan-speed control device 300 may be configured to turn the ceiling fan on and off and/or to control the rotational speed S_{FAN} of the ceiling fan in response to commands received in messages via the communication circuit.

The fan-speed control device 300 may be configured to control the rotational speed S_{FAN} of the ceiling fan to, for example, a total number N_{PRE-TOT} of preset speeds (e.g., four discrete speeds), such as a first preset speed S_{PRE-1} (e.g., a low speed), a second preset speed S_{PRE-2} (e.g., a medium-low speed), a third preset speed S_{PRE-3} (e.g., a medium-high speed), and/or a fourth preset speed S_{PRE-4} (e.g., a high speed). In some examples, the fan-speed control device 300 may be coupled in series electrical connection between a power source (e.g., an alternating-current (AC) power source and/or a direct-current (DC) power source) and a motor of the ceiling fan (e.g., the motor 112a of the first ceiling fan 110a). The fan-speed control device 300 may be configured to control a load current conducted through the motor of the ceiling fan using an internal motor control circuit (e.g., the fan-speed control device 300 may be deployed as the first fan-speed control device 120 of the load control system 100). The fan-speed control device 300 may be configured to turn the ceiling fan on and off and/or adjust the rotational speed S_{FAN} of the ceiling fan by controlling the load current conducted through the motor. In addition, the fan-speed control device 300 may be configured to transmit, via the communication circuit to an external fan-speed control device (e.g., the second fan-speed control device 130), a message including control data (e.g., one or more commands) for controlling a ceiling fan controlled by the external fan-speed control device (e.g., the fan-speed control device 300 may be deployed as the remote control device 140 of the load control system 100).

In some examples, the fan-speed control device 300 may comprise a rear enclosure 330 for housing motor control circuitry of the fan-speed control device 300 (e.g., when the fan-speed control device 300 is a wall-mounted fan-speed control device, such as the first fan-speed control device 120 shown in FIG. 1). For example, the rear enclosure 330 may enclose a portion (e.g., one or more components) of the fan-speed control device 300. The fan-speed control device 300 may be configured to be mounted to an electrical wallbox (e.g., a metal wallbox).

The user interface 302 of the fan-speed control device 300 may include an actuation member 310. For example, the actuator member 310 may be mounted (e.g., pivotably mounted) to be mounted to a bezel 306 (e.g., a base portion). The actuation member 310 may comprise a front surface 315 including an upper portion 316 and a lower portion 318. The user interface 302 may include a light bar 320 extending along the length of the front surface 315 of the actuation member 310 for a length L_{LB} from a top end 326 to a bottom end 328. The light bar 320 may be configured to be illuminated by one or more light sources (e.g., one or more LEDs) to visibly display information. The actuation member 310 may be configured to pivot about a pivot axis 308 (e.g., a central axis) in response to a tactile actuation (e.g., a tactile input) of the upper portion 316 and the lower portion 318. The pivot axis 308 may be located near a center 317 of the actuation member 310. The fan-speed control device 300 may be configured to control the ceiling fan to turn the ceiling fan on in response to a tactile actuation of the upper portion 316, and to turn the ceiling fan off in response to a tactile actuation (e.g., a tactile input) of the lower portion 318 (or vice versa). For example, when the fan-speed control device 300 detects a tactile actuation of the upper portion 316 of the actuation member 310 and the ceiling fan is off, the fan-speed control device 300 may be configured to turn the ceiling fan on to a previous rotational speed (e.g., before the ceiling fan was previously turned off) or to a predetermined rotational speed (e.g., a locked rotational speed). When the fan-speed control device 300 detects a tactile actuation of the upper portion 316 of the actuation member 310 and the ceiling fan is on, the fan-speed control device 300 may be configured to adjust the rotational speed S_{FAN} of the ceiling fan to the fourth preset speed S_{PRE-4} (e.g., the maximum, high, or full-on speed). The fan-speed control device 300 may include one or more tactile switches that are actuated in response to the tactile actuations of the upper and/or lower portions 316, 318 of the actuation member 310.

The user interface 302 of the fan-speed control device 300 may comprise an air-gap actuator 319. For example, the air-gap actuator 319 may be located on the bezel 306 below the actuation member 310. The air-gap actuator 319 may be actuated an internal air-gap switch that may be coupled in series with the internal motor control circuit and the motor of the ceiling fan. For example, the air-gap actuator 319 may be pulled out from the bezel 306 to open the internal air-gap switch to thus disconnect the motor the ceiling fan from the power source (e.g., such that the fan-speed control device 300 and the motor of the ceiling fan are unpowered). When the air-gap actuator 319 is not pulled out from the bezel 306 (e.g., as shown in FIG. 3A), the internal air-gap switch may be closed, such that the internal motor control circuit of the fan-speed control device 300 is coupled in series between the power source and the motor of the ceiling fan and the fan-speed control device 300 is configured to control the load current conducted through the motor.

The fan-speed control device 300 may be configured to control the ceiling fan in response to a touch actuation of the actuation member 310. For example, the actuation member 310 may also receive user inputs that do not cause the actuation member 310 to pivot (e.g., about the pivot axis 308). At least a portion of the front surface 315 of the actuation member 310 may be configured as a touch sensitive surface (e.g., a capacitive touch surface) and a touch sensitive device that includes circuitry configured to receive (e.g., detect) inputs (e.g., touch actuations/inputs) on the touch sensitive surface, such as point actuations or gestures, from a user of the fan-speed control device 300. The touch sensitive surface of the actuation member 310 may be located adjacent to and/or overlap with the light bar 320, and may extend from approximately the top end 326 to the bottom end 328 of the light bar 320. Examples of control devices having capacitive touch surfaces and/or touch sensitive devices are described in greater detail in commonly-assigned U.S. Pat. No. 10,109,181, issued Oct. 23, 2018, entitled GESTURE-BASED CONTROL DEVICE FOR CONTROLLING AN ELECTRICAL LOAD, and U.S. Pat. No. 11,569,818, issued Jan. 31, 2023, entitled LOAD CONTROL DEVICE HAVING A CAPACITIVE TOUCH SURFACE, the entire disclosures of which are hereby incorporated by reference. Although described primarily in context of a capacitive touch surface, it should be appreciated that the fan-speed control device 300 is not so limited, and in some examples, at least a portion of the front surface 315 of the actuation member 310 may be configured as a different type of touch sensitive surface, such as a resistive touch surface, an inductive touch surface, a surface acoustic wave (SAW) touch surface, an infrared touch surface, acoustic pulse touch surface, or the like. In addition, the fan-speed control device 300 may not comprise a capacitive touch surface, but may comprise an alternative fan-speed control actuator, such as a slider control and/or a rocker switch for raising and lowering the rotational speed S_{FAN} of the ceiling fan.

The actuation member 310 may substantially maintain its position (e.g., with respect to the bezel 306) in response to touch actuations of the touch sensitive surface and, depending on the positions of the touch actuations, the control device 300 may be configured to enter different operating modes and/or carry out different control functions in response. For example, during a normal operating mode, the fan-speed control device 300 may be configured to adjust the amount of power delivered to, and thus the rotational speed S_{FAN} of, the ceiling fan according to the position of the touch actuation on the front surface 315 of the actuation member 310 along the light bar 320 (e.g., along the touch sensitive surface). In addition, the fan-speed control device 300 may be configured to receive advanced touch actuations of the front surface 315 of the actuation member 310 along the light bar 320 (e.g., of the touch sensitive surface). The advanced touch actuations of the front surface 315 of the actuation member 310 may comprise, for example, a gesture (e.g., a swipe) or a press-and-hold actuation of the touch sensitive surface. For example, the fan-speed control device 300 may be configured to transmit a command to the ceiling fan to change the rotational direction of the ceiling fan in response to detecting a swipe of the light bar 320 in a first direction followed by a swipe of the light bar 320 in a second opposing direction in quick succession. In addition, the fan-speed control device 300 may be configured to change operating modes in response to detecting an advanced touch actuation. For example, the fan-speed control device 300 may be configured to change to a configuration mode in response to detecting a press-and-hold actuation of the touch sensitive surface at the center 317 of the light bar 320 (e.g., that does not cause the actuation member 310 to pivot).

The fan-speed control device 300 may be configured to control the rotational speed S_{FAN} of the ceiling fan to one of the preset speeds S_{PRE-1}-S_{PRE-4} based on the position of a touch actuation (e.g., a touch input) along the touch sensitive surface of the actuation member 310. For example, the fan-speed control device 300 may be configured to control the rotational speed S_{FAN} of the ceiling fan to one of the preset speeds S_{PRE-1}-S_{PRE-4} depending upon which one of four regions (e.g., a first region 311, a second region 312, a third region 313, and a fourth region 314) of the touch sensitive surface on the actuation member 310 along the light bar 320 is actuated with the touch actuation. The touch sensitive surface of the actuation member 310 may extend from approximately the top end 326 to the bottom end 328 of the light bar 320 (e.g., adjacent to and/or overlapping with the light bar 320). The first, second, third, and fourth regions 311-314 may each extend for a respective length along the light bar 320, where the first region 311 may be located at the bottom end 328 of the light bar 320, the second region 312 may be located above the first region 311, the third region 313 may be located above the second region 312, and the fourth region 314 may be located above the third region 313 (e.g., at the top end 326 of the light bar 320). The second region 312 and the third region 313 may meet at a midpoint 327 of the light bar 320. For example, the respective lengths of the first, second, third, and fourth regions 311-314 along the light bar 320 may be substantially the same. The fan-speed control device 300 may be configured to control the rotational speed S_{FAN} of the ceiling fan to the first preset speed S_{PRE-1} in response to a touch actuation of the actuation member 310 in the first region 311 along the light bar 320. The fan-speed control device 300 may be configured to control the rotational speed S_{FAN} of the ceiling fan to the second preset speed S_{PRE-2} in response to a touch actuation of the actuation member 310 in the second region 312 along the light bar 320. The fan-speed control device 300 may be configured to control the rotational speed S_{FAN} of the ceiling fan to the third preset speed S_{PRE-3} in response to a touch actuation of the actuation member 310 in the third region 313 along the light bar 320. The fan-speed control device 300 may be configured to control the rotational speed S_{FAN} of the ceiling fan to the fourth preset speed S_{PRE-4} in response to a touch actuation of the actuation member 310 in the fourth region 314 along the light bar 320.

The fan-speed control device 300 may be also configured to control the rotational speed S_{FAN} of the ceiling fan to one of the preset speeds S_{PRE-1}-S_{PRE-4} in response to a message via the communication circuit. For example, the message may include a command for controlling the rotational speed S_{FAN} of the ceiling fan to one of the preset speeds S_{PRE-1}-S_{PRE-4}. In addition, the fan-speed control device 300 may be configured to transmit a message including a command for controlling a rotational speed S_{FAN} of a ceiling fan controlled by an external fan-speed control device (e.g., the second fan-speed control device 130) to one of the preset speeds S_{PRE-1}-S_{PRE-4} based on the position of a touch actuation along the touch sensitive surface of the actuation member 310.

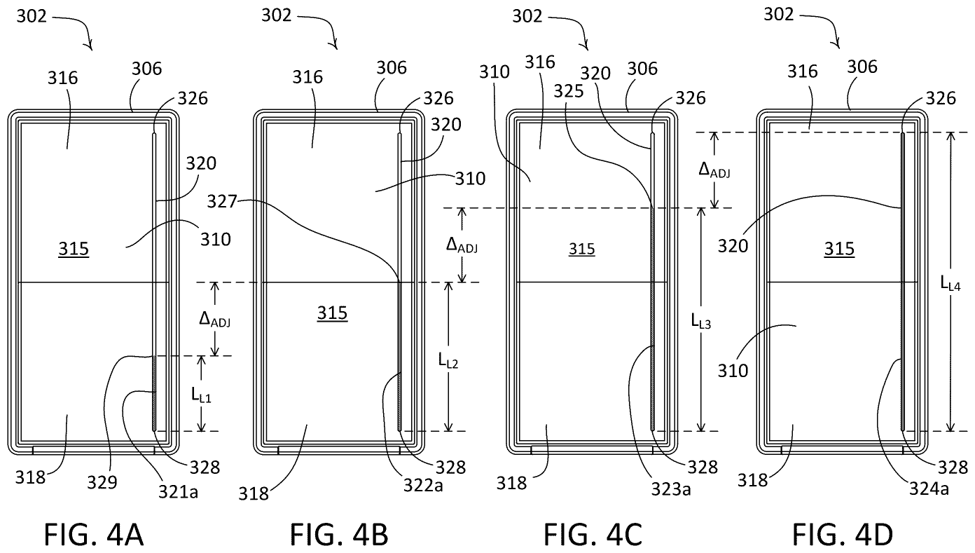

The fan-speed control device 300 may be configured to control the one or more light sources to illuminate the light bar 320 to indicate which of the first, second, third, or fourth preset speeds S_{PRE-1}-S_{PRE-4} that the fan-speed control device 300 is presently controlling the ceiling fan. FIGS. 4A-4D are front views of the user interface 302 of the fan-speed control device 300 that illustrate illumination on the light bar 320 to indicate the first, second, third, or fourth preset speeds S_{PRE-1}-S_{PRE-4}, respectively. As shown in FIGS. 4A-4D, when the fan-speed control device 300 changes the rotational speed S_{FAN} of the ceiling fan from one speed to the next higher or lower speed, the fan-speed control device 300 may be configured to adjust an illuminated portion of the light bar 320 by an adjustment amount Δ_{ADJ}, which may be approximately 25% of the length L_{LB} of the light bar 320.

When the fan-speed control device 300 is controlling the rotational speed S_{FAN} of the ceiling fan to the first preset speed S_{PRE-1} (e.g., the minimum or low speed), the fan-speed control device 300 may be configured to illuminate a first illuminated portion 321a of the light bar 320 that extends from the bottom end 328 of the light bar 320 to a first point (e.g., a point 329) for a first length L_{L1} along the light bar 320. For example, the first length L_{L1} may be approximately 25% of the length L_{LB} of the light bar 320. When the fan-speed control device 300 is controlling the rotational speed S_{FAN} of the ceiling fan to the second speed S_{PRE-2} (e.g., the medium-low speed), the fan-speed control device 300 may be configured to illuminate a second illuminated portion 322a of the light bar 320 that extends from the bottom end 328 to a second point (e.g., the midpoint 327 of the light bar 320) for a second length L_{L2} along the light bar 320. For example, the second length L_{L2} may be approximately 50% of the length L_{LB} of the light bar 320. When the fan-speed control device 300 is controlling the rotational speed S_{FAN} of the ceiling fan to the third speed S_{PRE-3} (e.g., the medium-high speed), the fan-speed control device 300 may be configured to illuminate a third illuminated portion 323a of the light bar 320 that extends from the bottom end 328 of the light bar 320 to a third point (e.g., a point 325) for a third length L_{L3} along the light bar 320. For example, the third length L_{L3} may be approximately 75% of the length L_{LB} of the light bar 320. When the fan-speed control device 300 is controlling the rotational speed S_{FAN} of the ceiling fan to the fourth speed S_{PRE-4} (e.g., the maximum or high speed), the fan-speed control device 300 may be configured to illuminate a fourth illuminated portion 324a of the light bar 320 that extends from the bottom end 328 to a fourth point (e.g., the top end 326 of the light bar 320) for a fourth length L_{L} along the light bar 320. For example, the fourth length L_{L} may be approximately 100% of the length L_{LB} of the light bar 320 (e.g., the fourth length L_{L} may be equal to the length L_{LB} of the light bar 320).

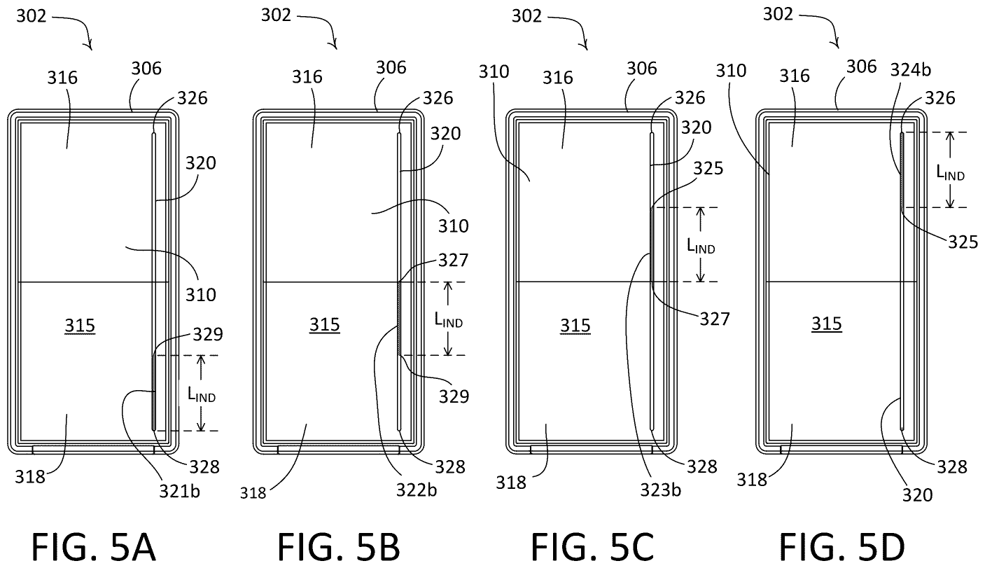

In some examples, the fan-speed control device 300 may be configured to control the one or more light sources to illuminate the light bar 320, such that the lengths of the illuminated portions of the light bar 320 are each an indication length L_{IND}. FIGS. 5A-5D are front views of the user interface 302 of the fan-speed control device 300 that illustrate illumination on the light bar 320 to indicate the first, second, third, or fourth preset speeds S_{PRE-1}-S_{PRE-4}, respectively, when the lengths of the illuminated portions of the light bar 320 are each the indication length L_{IND}. For example, the indication length L_{IND} may be approximately 25% of the length L_{LB} of the light bar 320 (e.g., when there are four discrete speeds). When the fan-speed control device 300 is controlling the rotational speed S_{FAN} of the ceiling fan to the first preset speed S_{PRE-1} (e.g., the minimum or low speed), the fan-speed control device 300 may be configured to illuminate a first illuminated portion 321b of the light bar 320 that extends from the bottom end 328 of the light bar 320 for the indication length L_{IND} along the light bar 320 to the point 329. When the fan-speed control device 300 is controlling the rotational speed S_{FAN} of the ceiling fan to the second preset speed S_{PRE-2} (e.g., the medium-low speed), the fan-speed control device 300 may be configured to illuminate a second illuminated portion 322b of the light bar 320 that extends from the point 329 for the indication length L_{IND} along the light bar 320 to the midpoint 327. When the fan-speed control device 300 is controlling the rotational speed S_{FAN} of the ceiling fan to the third preset speed S_{PRE-3} (e.g., the medium-high speed), the fan-speed control device 300 may be configured to illuminate a third illuminated portion 323b of the light bar 320 that extends from the midpoint 327 for the indication length L_{IND} along the light bar 320 of the light bar 320 to the point 325. When the fan-speed control device 300 is controlling the rotational speed S_{FAN} of the ceiling fan to the fourth preset speed S_{PRE-4} (e.g., the maximum or high speed), the fan-speed control device 300 may be configured to illuminate a fourth illuminated portion 324b of the light bar 320 that extends from the point 325 for the indication length L_{IND} along the light bar 320 to the top end 326. In some examples, the first, second, third, and fourth illuminated portions 321b-324b do not overlap (e.g., as shown in FIGS. 5A-5D). Additionally or alternatively, the first, second, third, and fourth illuminated portions 321b-324b may overlap slightly, e.g., due to dispersion of light shining through a diffuser of the fan-speed control device 300.

The fan-speed control device 300 may control the magnitude of the load current conducted through the motor of the ceiling fan based on a single discrete input along the touch sensitive surface and/or based on a plurality of consecutive inputs along the touch sensitive surface. For example, the user may tap their finger at a position along the touch sensitive surface, and in response, the fan-speed control device 300 may turn the ceiling fan on to a rotational speed based on the position (e.g., to one of the first, second, third, or fourth preset speeds S_{PRE-1}-S_{PRE-4} depending upon which of the first, second, third, or fourth regions 311-314 on the actuation member 310 along the light bar 320 is actuated). As an example, if the ceiling fan is off, the fan-speed control device 300 may turn the ceiling fan on to a rotational speed based on the position of a touch actuation along the touch sensitive surface of the actuation member 310. While the ceiling fan is on, the user may move (e.g., slide) their finger along the touch sensitive surface, and in response, the fan-speed control device 300 may adjust the rotational speed of the ceiling fan to one of the first, second, third, or fourth preset speeds S_{PRE-1}-S_{PRE-4} based on the user's finger moving between the regions 311-314 on the actuation member 310 along the light bar 320.

The internal motor control circuit of the fan-speed control device 300 may be configured to adjust the rotational speed S_{FAN} of the ceiling fan to a total number N_{POS-TOT} of possible speeds that is greater than the total number N_{P}RE-TOT of the preset speeds S_{PRE-1}-S_{PRE-4} (e.g., greater than four). The motor control circuit of the fan-speed control device 300 may be configured to control the rotational speed S_{FAN} of the ceiling fan to, for example, one of the total number N_{POS-TOT} (e.g., seven) of discrete possible speeds S_{POS-1}-S_{POS-7}. For example, the first possible speed S_{POS-1} may be a minimum speed to which the ceiling fan may be controlled by the internal motor control circuit and the seventh possible speed S_{POS-7} may be a maximum speed to which the ceiling fan may be controlled by the internal motor control circuit (e.g., a full-on speed). The fan-speed control device 300 may be configured to set each of the preset speeds S_{PRE-1}-S_{PRE-4} to one of the possible speeds S_{POS-1}-S_{POS-7} (e.g., in response to user inputs).

The fan-speed control device 300 may be configured to set the preset speeds S_{PRE-1}-S_{PRE-4} in response to inputs received, for example, via the user interface 302. For example, the fan-speed control device 300 may be configured to set the preset speeds S_{PRE-1}-S_{PRE-4} in response to inputs received via the user interface 302 when operating in an advanced programming mode (APM). The fan-speed control device 300 may be configured to enter the advanced programming mode in response to inputs received via the user interface 302. For example, the fan-speed control device 300 may be configured to enter the advanced programming mode in response to the user pulling out the air-gap switch actuator 319, pressing and holding the upper portion 316 of the actuation member 310 while pushing in the air-gap switch actuator 319, and then holding the upper portion 316 of the actuation member 310 for a period of time (e.g., approximately six seconds).

After entering the advanced programming mode, the fan-speed control device 300 may be configured to illuminate at least a portion of the light bar 320 to indicate one of the preset speeds S_{PRE-1}-S_{PRE-4} to be configured. For example, the fan-speed control device 300 may be configured to illuminate the light bar 320 as shown in FIGS. 4A-4D and/or in FIGS. 5A-5D (e.g., in the same or similar manner as illuminating the light bar 320 to indication the rotational speed S_{FAN} of the ceiling fan). The fan-speed control device 300 may adjust the one of the preset speeds S_{PRE-1}-S_{PRE-4} to be configured in response to an actuation (e.g., a touch actuation) of the front surface 315 of the actuation member 310 (e.g., the touch sensitive surface) along the light bar 320 (e.g., in one of the first, second, third, and fourth regions 311-314). The fan-speed control device 300 may be configured to adjust the illumination of the light bar 320 to indicate the one of the preset speeds S_{PRE-1}-S_{PRE-4} to be configured in response to the actuation of the front surface 315 of the actuation member 310 along the light bar 320. The fan-speed control device 300 may receive an indication of a selected preset speed S_{PRE-SEL}, which may be the one of the preset speeds S_{PRE-1}-S_{PRE-4} that is presently being indicated. For example, the fan-speed control device 300 may receive the indication of the selected preset speed S_{PRE-SEL} in response to an actuation of the lower portion 318 of the actuation member 310.

After receiving the indication of the preset speed S_{PRE}, the fan-speed control device 300 may be configured to illuminate at least a portion of the light bar 320 to indicate one of the possible speeds S_{POS-1}-S_{POS-7} to be set as the selected preset speed S_{PRE-SEL}. For example, the fan-speed control device 300 may be configured to illuminate a portion of the light bar 320 that has a length that is approximately one-seventh of the length L_{LB} of the light bar 320 to indicate one of the possible speeds S_{POS-1}-S_{POS-7}. The fan-speed control device 300 may adjust the one of the possible speeds S_{POS-1}-S_{POS-7} to be set as the selected preset speed S_{PRE-SEL} in response to an actuation (e.g., a touch actuation) of the front surface 315 of the actuation member 310 (e.g., the touch sensitive surface) along the light bar 320 (e.g., in one of seven regions along the light bar 320). The fan-speed control device 300 may be configured to adjust the illumination of the light bar 320 to indicate the one of the possible speeds S_{POS-1}-S_{POS-7} to be set as the selected preset speed S_{PRE-SEL} in response to the actuation of the front surface 315 of the actuation member 310 along the light bar 320. The fan-speed control device 300 may receive an indication of a selected possible speed S_{POS-SEL}, which may be the one of the possible speeds S_{POS-1}-S_{POS-7} that is presently being indicated. For example, the fan-speed control device 300 may receive the indication of the selected possible speed S_{POS-SEL} in response to an actuation of the lower portion 318 of the actuation member 310. The fan-speed control device 300 may be configured to store the selected possible speed S_{POS-SEL} as the selected preset speed S_{PRE-SEL} in memory. The selected preset speed S_{PRE-SEL} and the selected possible speed S_{POS-SEL} may be stored in memory as, for example, integer values. For example, the selected preset speed S_{PRE-SEL} and the selected possible speed S_{POS-SEL} may be stored in memory as a selected preset speed number N_{PRE-SEL} (e.g., which may range from 1 to 4) and a selected possible speed number N_{POS-SEL} (e.g., which may range from 1 to 7), respectively.

The fan-speed control device 300 may also be configured to set the preset speeds S_{PRE-1}-S_{PRE-4} in response to, for example, configuration data (e.g., preset configuration data) in a message received via the communication circuit. For example, the fan-speed control device 300 may be configured to receive the message including the configuration data for setting the preset speeds S_{PRE-1}-S_{PRE-4} from a system controller (e.g., the system controller 150) and/or a network device (e.g., the network device 160). The confirmation information may indicate one or the preset speeds S_{PRE-1}-S_{PRE-4} (e.g., a selected preset speed S_{PRE-SEL}) and one of the possible speeds S_{POS-1}-S_{POS-4} (e.g., a selected possible speed S_{POS-SEL}). The fan-speed control device 300 may be configured to store the configuration data (e.g., to store the selected possible speed S_{POS-SEL} as the selected preset speed S_{PRE-SEL}) in memory. The selected preset speed S_{PRE-SEL} and the selected possible speed S_{POS-SEL} may be stored in memory as, for example, integer values. For example, the selected preset speed S_{PRE-SEL} and the selected possible speed S_{POS-SEL} may be stored in memory as a selected preset speed number N_{PRE-SEL} (e.g., which may range from 1 to 4) and a selected possible speed number N_{POS-SEL} (e.g., which may range from 1 to 7), respectively.

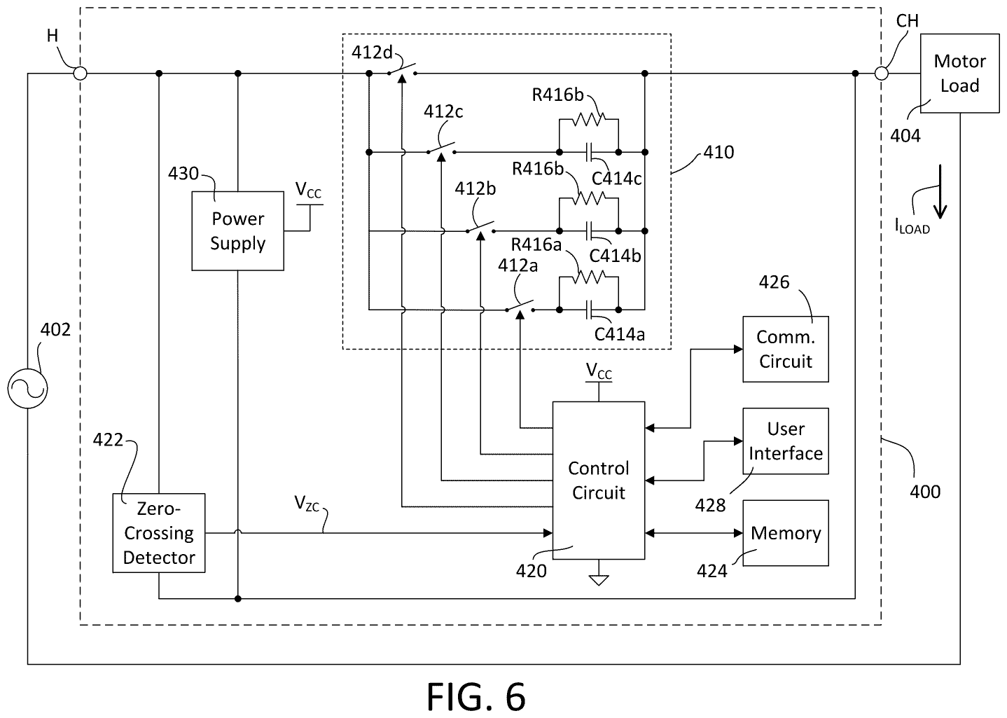

FIG. 6 is a simplified block diagram of an example of a fan-speed control device 400 that may be deployed as, for example, the fan-speed control devices 120, 130 of the load control system 100 shown in FIG. 1 and/or the fan-speed control device 300 shown in FIGS. 3A-5B. The fan-speed control device 400 may include a hot terminal H that may be adapted to be coupled to a power source 402, such as an alternating-current (AC) power source. In some examples, the power source 402 may comprise a direct-current (DC) power source. The fan-speed control device 400 may include a controlled-hot terminal CH that may be adapted to be coupled to an electrical load, such as a motor load 404, such as a motor of a ceiling fan (e.g., the motors 112a, 112b of the respective ceiling fans 110a, 110b). The fan-speed control device 400 may include a load control circuit, such as a motor control circuit 410, coupled in series electrical connection between the power source 402 and the motor load 404. The motor control circuit 410 may be configured to control the power delivered to the motor load 404. The fan-speed control device 400 may include a control circuit 420 configured to control the motor control circuit 410 to control the power delivered to the motor load 404 to thus control a rotational speed S_{MOTOR} of the motor load 404. The control circuit 420 may include one or more of a processor (e.g., a microprocessor), a microcontroller, a programmable logic device (PLD), a field programmable gate array (FPGA), an application specific integrated circuit (ASIC), or any suitable controller or processing device.

The motor control circuit 410 may be capable of controlling the rotational speed S_{MOTOR} of the motor load 404 to a total number N_{POS-TOT} of possible speeds S_{POS-1}-S_{POS-7} (e.g., seven discrete speeds), such as a first possible speed S_{POS-1} (e.g., a minimum speed), a second possible speed S_{POS-2}, a third possible speed S_{POS-3}, a fourth possible speed S_{POS-4}, a fifth possible speed S_{POS-5}, a sixth possible speed S_{POS-6}, and/or a seventh possible speed S_{POS-7} (e.g., a maximum speed). For example, the possible speeds S_{POS-1}-S_{POS-7} may increase in speed in order (e.g., from the first possible speed S_{POS-1} to the seventh possible speed S_{POS-7}). The motor control circuit 410 may comprise a first controllable switching circuit 412a, a second controllable switching circuit 412b, a third controllable switching circuit 412c, and a fourth controllable switch circuit 412d. For example, the first, second, third, and fourth controllable switching circuits 412a, 412b, 412c, 412d may each comprise a bidirectional semiconductor switch, such as a thyristor (e.g., a triac or one or more silicon-controlled rectifiers), a field-effect transistor (FET) in a rectifier bridges, two FETs in anti-series connection, one or more insulated-gate bipolar junction transistors (IGBTs), or other suitable bidirectional semiconductor switches. In addition, the first, second, third, and fourth controllable switching circuits 412a, 412b, 412c, 412d may each comprise a relay or other suitable controllably conductive device. The control circuit 420 may be configured to control (e.g., independently control) the first, second, third, and fourth controllable switching circuits 412a, 412b, 412c, 412d to render the first, second, third, and fourth controllable switching circuits 412a, 412b, 412c, 412d conductive and non-conductive.

The first controllable switching circuit 412a may be coupled in series with a first capacitor C414a, such that the series combination of the first controllable switching circuit 412a and the first capacitor C414a may be coupled in series between the hot terminal H and the controlled-hot terminal CH. The second controllable switching circuit 412b may be coupled in series with a second capacitor C414b, such that the series combination of the second controllable switching circuit 412b and the second capacitor C414b may be coupled in series between the hot terminal H and the controlled-hot terminal CH. The third controllable switching circuit 412c may be coupled in series with a third capacitor C414c, such that the series combination of the third controllable switching circuit 412c and the third capacitor C414c may be coupled in series between the hot terminal H and the controlled-hot terminal CH. For example, the first, second, and third capacitors C414a, C414b, C414c may have different capacitances, e.g., approximately 1 μF, 2.2 μF, and 3.3 μF, respectively. The fourth controllable switching circuit 412d may be coupled (e.g., directly coupled) in series between the hot terminal H and the controlled-hot terminal CH. The series combination of the first controllable switching circuit 412a and the first capacitor C414a, the series combination of the second controllable switching circuit 412b and the second capacitor C414b, the series combination of the third controllable switching circuit 412c and the third capacitor C414c and the fourth controllable switching circuit 412d may be coupled in parallel with each other. In addition, the motor control circuit 410 may comprise a first resistor R416a coupled in parallel with the first capacitor C414a for discharging the first capacitor C414a when the first controllable switching circuit 412a is non-conductive, a second resistor R416b coupled in parallel with the second capacitor C416b for discharging the second capacitor C416b when the second controllable switching circuit 412b is non-conductive, and a third resistor R416c coupled in parallel with the third capacitor C416c for discharging the third capacitor C416c when the third controllable switching circuit 412c is non-conductive.

The control circuit 420 may be configured to render (e.g., independently render) the first, second, third, and fourth controllable switching circuits 412a, 412b, 412c, 412d conductive and non-conductive to control a magnitude of a load current I_{LOAD} conducted through the motor load 404 to control the rotational speed S_{MOTOR} of the motor load 404 to one or more of the total number N_{POS-TOT} of possible speeds S_{POS-1}-S_{POS-7}. The control circuit 420 may be configured to render the first controllable switching circuit 412a conductive to electrically couple the first capacitor C414a in series between the power source 402 and the motor load 404 to control the rotational speed S_{MOTOR} of the motor load 404 to the first possible speed S_{POS-1}. The control circuit 420 may be configured to render the second controllable switching circuit 412b conductive to electrically couple the second capacitor C414b in series between the power source 402 and the motor load 404 to control the rotational speed S_{MOTOR} of the motor load 404 to the second possible speed S_{POS-2}. The control circuit 420 may be configured to render the third controllable switching circuit 412c conductive to electrically couple the third capacitor C414c in series between the power source 402 and the motor load 404 to control the rotational speed S_{MOTOR} of the motor load 404 to the third possible speed S_{POS-3}. The control circuit 420 may be configured to render the first and third controllable switching circuits 412a, 412c conductive to electrically couple the first and third capacitors C414a, C414c in parallel between the power source 402 and the motor load 404 to control the rotational speed S_{MOTOR} of the motor load 404 to the fourth possible speed S_{POS-4}. The control circuit 420 may be configured to render the second and third controllable switching circuits 412b, 412c conductive to electrically couple the second and third capacitors C414b, C414c in parallel between the power source 402 and the motor load 404 to control the rotational speed S_{MOTOR} of the motor load 404 to the fifth possible speed S_{POS-5}. The control circuit 420 may be configured to render the first, second, third, and fourth controllable switching circuits 412a, 412b, 412c conductive to electrically couple the first, second, and third capacitors C414a, C414b, C414c in parallel between the power source 402 and the motor load 404 to control the rotational speed S_{MOTOR} of the motor load 404 to the sixth possible speed S_{POS-6}. The control circuit 420 may be configured to render the fourth controllable switching circuit 412d conductive to bypass the first, second, and third capacitors C414a, C414b, C414c to control the rotational speed S_{MOTOR} of the motor load 404 to the seventh possible speed S_{POS-7}.

In the example described herein, the control circuit 420 may not render the first and second controllable switching circuits 412a, 412b conductive to electrically couple the first and second capacitors C414a, C414b in parallel between the power source 402 and the motor load 404 to control the motor load 404 to control the rotational speed S_{MOTOR} of the motor load 404 to an eighth possible speed S_{POS-8}. This may have been done because of the particular capacitances selected for the respective first, second, and third capacitors C414a, C414b, C414C. For instance, if the first, second, and third capacitors C414a, C414b, C414c have capacitances of approximately 1 μF, 2.2 μF, and 3.3 μF, respectively, then the total capacitance created when the first and second controllable switching circuits 412a, 412b are rendered conductive (e.g., 1 ρF+2.2 μF=3.2 μF) is substantially equal to the total capacitance created when just the third controllable switching circuits 412c is rendered conductive (e.g., 3.3 μF), so this operation is not performed by the control circuit 420 in some examples. However, if the capacitances of the first, second, and third capacitors C414a, C414b, C414c are selected to be different values (e.g., where the combined capacitance of the first and second capacitors C414a, C414b does not equal the capacitance of the third capacitor C414c), then the control circuit 420 may be configured to render the first and second controllable switching circuits 412a, 412b conductive to electrically couple the first and second capacitors C414a, C414b in parallel between the power source 402 and the motor load 404 to control the rotational speed S_{MOTOR} of the motor load 404 to the eighth possible speed S_{POS-8}, such that the fan-speed control device 400 may be configured with up to eight possible speed S_{POS-1}-S_{POS-8}. For example, in some examples, the eighth possible speed S_{POS-8} may be between the third possible speed S_{POS-3} and the fourth possible speed S_{POS-4}.

The fan-speed control device 400 may include a power supply 430. The power supply 430 may generate a direct-current (DC) supply voltage V_{CC} for powering the control circuit 420 and the other low-voltage circuitry of the fan-speed control device 400. The power supply 430 may be coupled between the hot terminal H and the controlled-hot terminal CH (e.g., in parallel with the motor control circuit 410). The power supply 430 may be configured to conduct a charging current through the motor load 404 to generate the DC supply voltage V_{CC}.

The fan-speed control device 400 may comprise a zero-crossing detector 422 (e.g., a zero-cross detect circuit) electrically coupled between the hot terminal H and the controlled-hot terminal CH. The zero-crossing detector 422 may be configured to generate a zero-cross detect signal V_{ZC} that indicates the zero-crossing points of an AC mains line voltage generated by the power source 402. The control circuit 420 may receive the zero-cross detect signal V_{ZC} and may be configured to render the first, second, third, and fourth controllable switching circuits 412a, 412b, 412c of the motor control circuit 410 based on the zero-cross detect signal V_{ZC}. For example, the control circuit 420 may be configured to render the first, second, third, and fourth controllable switching circuits 412a, 412b, 412c conductive and non-conductive at approximately the zero-crossings of the AC mains line voltage as determined from the zero-cross detect signal V_{ZC} received from the zero-crossing detector 422.

The fan-speed control device 400 may comprise a memory 424 that may be communicatively coupled to the control circuit 420 for the storage and/or retrieval of data. The memory 424 may be implemented as an external integrated circuit (IC) or as an internal circuit of the control circuit 410. The memory 424 may comprise a computer-readable storage media or machine-readable storage media that maintains computer-executable instructions for performing one or more procedure and/or functions as described herein. For example, the memory 424 may comprise computer-executable instructions or machine-readable instructions that when executed by the control circuit 420 configure the control circuit 420 to provide one or more portions of the procedures described herein. The control circuit 420 may access the instructions from the memory 424 for being executed to cause the control circuit 420 to operate as described herein, or to operate one or more other devices as described herein. The memory 424 may comprise computer-executable instructions for executing configuration software. For example, the control circuit 420 may be configured to store in and retrieve from the memory 424 configuration data for configuring the fan-speed control devices of the load control system and/or control data for controlling the fan-speed control devices of the load control system. In addition, the control circuit 420 may be configured to store in and retrieve from the memory 424 configuration settings (e.g., operational settings), such as, association information (e.g., unique identifiers of control devices of the load control system), present rotational speeds and/or directions of the motor loads controlled by the fan-speed control devices, etc. For example, the operational characteristics stored in the memory 424 may be configured during a configuration procedure of the fan-speed control device 400.

The fan-speed control device 400 may comprise a communication circuit 426 configured to communicate (e.g., transmit and/or receive) messages (e.g., digital messages). For example, the communication circuit 426 may comprise one or more wired communication circuits and/or wireless communication circuits. The one or more wired communication circuits and/or wireless communication circuits of the communication circuit 426 may be implemented as external integrated circuits (ICs) or as internal circuits of the control circuit 420. For example, the one or more wireless communication circuits of the communication circuit 426 may include for example, one or more a radio-frequency (RF) transceivers coupled to a respective antenna for transmitting and/or receiving RF signals. In addition, the one or more wireless communication circuits of the communication circuit 426 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 426 may be capable of performing communication via the same communication channels or different communication channels. In some examples, the communication circuit 426 may be configured to communicate via a network, such as a wireless or wired local area network (LAN), e.g., for access to the Internet. In addition, the communication circuit 426 may be configured to communicate via a control network (e.g., a wired or wireless control communication link) for communicating with the fan-speed control devices of the load control system. The control circuit 420 may be configured to receive messages including control data (e.g., one or more commands) for controlling the motor load 404 via the communication circuit 426. The control circuit 420 may use the control data to control the motor control circuit 410 to adjust the rotational speed S_{MOTOR} of the motor load 404. In addition, the control circuit 420 may be configured to transmit, to an external fan-speed control device via the communication circuit 426, messages including control data (e.g., one or more commands) for controlling a motor load controlled by the external fan-speed control device. Further, the control circuit 420 may be configured to receive messages (e.g., including feedback data, such as status information of the fan-speed control devices) from the fan-speed control devices via the communication circuit 426.

The fan-speed control device 400 may further comprise a user interface circuit 428. The user interface circuit 428 may comprise one or more input circuits for receiving inputs. For example, the user interface circuit 428 may comprise one or more actuators configured to be actuated in response to actuation of one or more respective buttons of the fan-speed control device 400 (e.g., in response to actuations of the upper portion 316 and/or the lower portion 318 of the actuation member 310). In addition, the user interface circuit 428 may comprise a touch sensitive circuit (e.g., a capacitive or resistive touch element) that may be responsive to actuations (e.g., touch actuations) of a touch sensitive surface of the fan-speed control device 400 (e.g., the touch sensitive surface on the front surface 315 of the actuation member 310). The control circuit 420 may be configured to generate control data (e.g., one or more commands) for controlling the motor load 404 in response to the user inputs received via the user interface circuit 428. The control circuit 420 may use the control data to control the motor control circuit 410 to adjust the rotational speed S_{MOTOR} of the motor load 404. Further, the user interface circuit 428 may comprise one or more light sources configured to illuminate visual indicators of the fan-speed control device 400 for providing feedback information to a user. For example, the control circuit 420 may be configured to control the light sources of the user interface circuit 428 to illuminate a light bar (e.g., such as the light bar 320). For example, the light sources may comprise one or more light-emitting diodes (LEDs).

The control circuit 420 may control the motor load control circuit 410 to adjust the rotational speed S_{MOTOR} of the motor load 404 based on a position of a touch actuation along the touch sensitive surface (e.g., as determined by the user interface circuit 428. For example, the control circuit 420 may be configured to control the rotational speed S_{MOTOR} of the motor load 404 to one of a total number N_{PRE-TOT} of preset speeds (e.g., four discrete speeds), such as a first preset speed S_{PRE-1} (e.g., a low speed), a second preset speed S_{PRE-2} (e.g., a medium-low speed), a third preset speed S_{PRE-3} (e.g., a medium-high speed), and/or a fourth preset speed S_{PRE-4} (e.g., a high speed). The control circuit 420 may be configured to control the rotational speed S_{FAN} of the ceiling fan to one of the preset speeds S_{PRE-1}-S_{PRE-4} based on the position of a touch actuation (e.g., a touch input) along the touch sensitive surface. For example, the control circuit 420 may be configured to control the rotational speed S_{FAN} of the ceiling fan to one of the preset speeds S_{PRE-1}-S_{PRE-4} depending upon which one of four regions along the light bar (e.g., the regions 311-314 of the touch sensitive surface on the actuation member 310 along the light bar 320) in which the position of the touch actuation occurs. The control circuit 420 may be configured to control the rotational speed S_{MOTOR} of the motor load 404 to the first preset speed S_{PRE-1} when the user interface circuit 428 indicates that the position of the touch actuation is within a first region (e.g., the first region 311 along the light bar 320). The control circuit 420 may be configured to control the rotational speed S_{MOTOR} of the motor load 404 to the second preset speed S_{PRE-2} when the user interface circuit 428 indicates that the position of the touch actuation is within a second region (e.g., the second region 312 along the light bar 320). The control circuit 420 may be configured to control the rotational speed S_{MOTOR} of the motor load 404 to the third preset speed S_{PRE-3} when the user interface circuit 428 indicates that the position of the touch actuation is within a third region (e.g., the third region 313 along the light bar 320). The control circuit 420 may be configured to control the rotational speed S_{MOTOR} of the motor load 404 to the fourth preset speed S_{PRE-4} when the user interface circuit 428 indicates that the position of the touch actuation is within a fourth region (e.g., the fourth region 314 along the light bar 320).

The control circuit 420 may be configured to illuminate light sources of the user interface surface 428 to provide feedback of a status (e.g., the rotational speed S_{MOTOR}) of the motor load 404, in response to receiving indications of actuations of the actuators and/or the touch sensitive circuit of the user interface surface 428, to indicate a status of the control device 400, and/or to assist with a control operation (e.g., to configure the fan-speed control device 400, select an operational mode of the fan-speed control device 400, etc.). The control circuit 420 may be configured to control the light sources to illuminate the light bar to indicate which of the preset speeds S_{PRE-1}-S_{PRE-4} to which the fan-speed control device 400 is presently controlling the motor load 404 (e.g., as shown in FIGS. 4A-4D or in FIGS. 5A-5D).

When the control circuit 420 is controlling the rotational speed S_{MOTOR} of the motor load 404 to the first preset speed S_{PRE-1}, the control circuit 420 may be configured to illuminate a first illuminated portion of the light bar (e.g., the first illuminated portion 321a or 321b of the light bar 320) to indicate the first preset speed S_{PRE-1}. When the control circuit 420 is controlling the rotational speed S_{MOTOR} of the motor load 404 to the second preset speed S_{PRE-2}, the control circuit 420 may be configured to illuminate a second illuminated portion of the light bar (e.g., the second illuminated portion 322a or 322b of the light bar 320) to indicate the second preset speed S_{PRE-2}. When the control circuit 420 is controlling the rotational speed S_{MOTOR} of the motor load 404 to the third preset speed S_{PRE-3}, the control circuit 420 may be configured to illuminate a third illuminated portion of the light bar (e.g., the third illuminated portion 323a or 323b of the light bar 320) to indicate the third preset speed S_{PRE-3}. When the control circuit 420 is controlling the rotational speed S_{MOTOR} of the motor load 404 to the fourth preset speed S_{PRE-4}, the control circuit 420 may be configured to illuminate a fourth illuminated portion of the light bar (e.g., the fourth illuminated portion 324a or 324b of the light bar 320) to indicate the fourth speed S_{PRE-4}.

The control circuit 420 may be configured to set each of the preset speeds S_{PRE-1}-S_{PRE-4} to one of the possible speeds S_{POS-1}-S_{POS-7} (e.g., in response to user inputs). The control circuit 420 may be configured to set the preset speeds S_{PRE-1}-S_{PRE-4} in response to inputs received, for example, via the user interface circuit 428. For example, the control circuit 420 may be configured to set the preset speeds S_{PRE-1}-S_{PRE-4} in response to inputs received via the user interface circuit 428 when operating in an advanced programming mode (APM). The control circuit 420 may be configured to enter the advanced programming mode in response to inputs received via the user interface 202. The control circuit 420 may be configured to receive an indication of a selected preset speed S_{PRE-SEL} to configure and/or an indication of a selected possible speed S_{POS-SEL} to which to set the selected preset speed S_{PRE-SEL} in response to actuations of one or more buttons and/or touch actuations of a touch sensitive device of the user interface circuit 428 when the control circuit 420 is operating in the advanced programming mode. The control circuit 420 may be configured to store the configuration data (e.g., to store the selected possible speed S_{POS-SEL} as the selected preset speed S_{PRE-SEL}) in the memory 424. The control circuit 420 may be configured to store the selected preset speed S_{PRE-SEL} and the selected possible speed S_{POS-SEL} in the memory 424 as, for example, integer values. For example, the control circuit 420 may be configured to store the selected preset speed S_{PRE-SEL} and the selected possible speed S_{POS-SEL} in the memory 424 as a selected preset speed number N_{PRE-SEL} (e.g., which may range from 1 to 4) and a selected possible speed number N_{POS-SEL} (e.g., which may range from 1 to 7), respectively.

The control circuit 420 may also be configured to set the preset speeds S_{PRE-1}-S_{PRE-4} in response to, for example, configuration data (e.g., preset configuration data) in a message received via the communication circuit 426. For example, the control circuit 420 may be configured to receive the message including the configuration data for setting the preset speeds S_{PRE-1}-S_{PRE-4} from a system controller (e.g., the system controller 150) and/or a network device (e.g., the network device 160). The confirmation data may include an indication of a selected preset speed S_{PRE-SEL} to configure and/or an indication of a selected possible speed S_{POS-SEL} to which to set the selected preset speed S_{PRE-SEL}. The control circuit 420 may be configured to store the configuration data (e.g., to store the selected possible speed S_{POS-SEL} as the selected preset speed S_{PRE-SEL}) in the memory 424 (e.g., as the selected preset speed number N_{PRE-SEL} and the selected possible speed number N_{POS-SEL}, respectively).

In some examples, the control circuit 420 may be configured to adjust (e.g., continuously adjust) the rotational speed S_{FAN} of the ceiling fan to adjust between the minimum speed (e.g., the first possible speed S_{POS-1}) and the maximum speed (e.g., the seventh possible speed S_{POS-7}). To continuously adjust the rotational speed S_{FAN} of the ceiling fan, the control circuit 420 may be configured to render the controllable switching circuits 412a, 412b, 412c non-conductive, and control the controllable switching circuit 414d to control an amount of power delivered to the motor load 404. For example, when the power source 402 is an AC power source, the control circuit 420 may be configured to control the controllable switching circuit 414d using a phase-control power-limiting (e.g., dimming) technique (e.g., a forward phase-control technique and/or a reverse phase-control technique). When using the forward phase-control technique, the control circuit 420 may be configured to render the controllable switching circuit 414d non-conductive at a beginning of each half-cycle of the AC power source, render the controllable switching circuit 414d conductive at a control time (e.g., a firing time or firing angle) during the half-cycle, and maintain the controllable switching circuit 414d conductive through approximately an end of the half-cycle. The control circuit 420 may be configured to move the control time closer to the beginning of the half-cycle to increase the amount of power delivered to the motor load 404 and increase the rotational speed S_{FAN} of the ceiling fan, and move the control time closer to the end of the half-cycle to decrease the amount of power delivered to the motor load 404 and decrease the rotational speed S_{FAN} of the ceiling fan. When using the reverse phase-control technique, the control circuit 420 may be configured to render the controllable switching circuit 414d conductive at the beginning of each half-cycle of the AC power source, render the controllable switching circuit 414d non-conductive at a control time during the half-cycle, and maintain the controllable switching circuit 414d non-conductive through approximately the end of the half-cycle. The control circuit 420 may be configured to move the control time closer to the beginning of the half-cycle to decrease the amount of power delivered to the motor load 404 and decrease the rotational speed S_{FAN} of the ceiling fan, and move the control time closer to the end of the half-cycle to increase the amount of power delivered to the motor load 404 and increase the rotational speed S_{FAN} of the ceiling fan. In some examples, the motor load control circuit 410 may comprise (e.g., only comprise) a single controllable switching circuit (e.g., such as the controllable switching circuit 414d), and the control circuit 420 may be configured (e.g., only be configured) to control the single controllable switching circuit using the phase-control power-limiting technique.

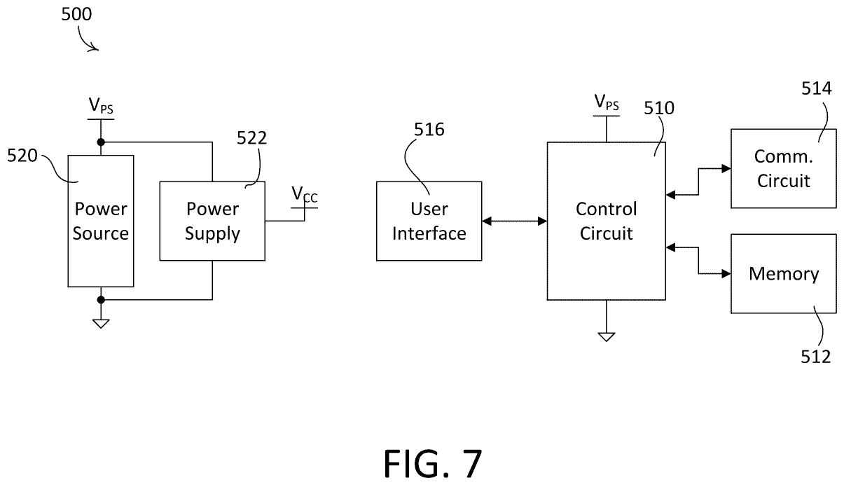

FIG. 7 is a block diagram of an example processing device 500, which may be deployed as the system controller 150, the network device 160, a computing device (e.g., a computer and/or a server) running a graphical user interface (GUI) software, and/or another processing device. The control device 500 may comprise a control circuit 510 configured to generate configuration data for configuring the operation of one or more control devices of a load control system (e.g., the load control system 100). In some examples, the control device 510 may be configured to generate control data (e.g., commands) for controlling one or more load control devices, such as fan-speed control devices (e.g., the fan-speed control devices 120, 130, 300, 400). The control circuit 510 may include one or more of a processor (e.g., a microprocessor), a microcontroller, a programmable logic device (PLD), a field programmable gate array (FPGA), an application specific integrated circuit (ASIC), or any suitable controller or processing device.

The processing device 500 may comprise a power source 520 for producing a power source voltage V_{PS}. For example, the power source 520 may comprise one or more batteries and/or a photo-voltaic power source (e.g., a solar cell). In addition, the power source 520 may comprise one or more energy storage elements, such as super capacitors and/or rechargeable batteries. Further, the power source 520 may also be configured to receive power from an external power source, such as an external direct-current (DC) power source or an alternating-current (AC) power source. The processing device 500 may also comprise a power supply 522 that may be configured to receive the power source voltage V_{PS} and generate a DC supply voltage V_{CC} for powering the control circuit 510 and other low-voltage circuitry of the processing device 500.

The processing device 500 may comprise a memory 512 that may be communicatively coupled to the control circuit 510 for the storage and/or retrieval of data. The memory 512 may be implemented as an external integrated circuit (IC) or as an internal circuit of the control circuit 510. The memory 512 may comprise a computer-readable storage media or machine-readable storage media that maintains computer-executable instructions for performing one or more procedure and/or functions as described herein. For example, the memory 512 may comprise computer-executable instructions or machine-readable instructions that when executed by the control circuit 510 configure the control circuit 510 to provide one or more portions of the procedures described herein. The control circuit 510 may access the instructions from the memory 512 for being executed to cause the control circuit 510 to operate as described herein, or to operate one or more other devices as described herein. The memory 512 may comprise computer-executable instructions for executing configuration software. For example, the control circuit 510 may be configured to store in and retrieve from the memory 512 configuration data for configuring the fan-speed control devices of the load control system and/or control data for controlling the fan-speed control devices of the load control system. In addition, the control circuit 510 may be configured to store in and retrieve from the memory 512 configuration settings (e.g., operational settings), such as, association information (e.g., unique identifiers of control devices of the load control system), present rotational speeds and/or directions of the motor loads controlled by the fan-speed control devices, etc. For example, the operational characteristics stored in the memory 512 may be configured during a configuration procedure of the processing device 500.

The processing device 500 may comprise a communication circuit 514 configured to communicate (e.g., transmit and/or receive) messages (e.g., digital messages). For example, the communication circuit 514 may comprise one or more wired communication circuits and/or wireless communication circuits. The one or more wired communication circuits and/or wireless communication circuits of the communication circuit 514 may be implemented as external integrated circuits (ICs) or as internal circuits of the control circuit 510. For example, the one or more wireless communication circuits of the communication circuit 514 may include for example, one or more a radio-frequency (RF) transceivers coupled to a respective antenna for transmitting and/or receiving RF signals. In addition, the one or more wireless communication circuits of the communication circuit 514 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 514 may be capable of performing communication via the same communication channels or different communication channels. In some examples, the communication circuit 514 may be configured to communicate via a network, such as a wireless or wired local area network (LAN), e.g., for access to the Internet. In addition, the communication circuit 514 may be configured to communicate via a control network (e.g., a wired or wireless control communication link) for communicating with the fan-speed control devices of the load control system. The control circuit 510 may be configured to transmit messages including control data (e.g., one or more commands) for controlling the fan-speed control devices via the communication circuit 514. In addition, the control circuit 510 may be configured to receive messages (e.g., including feedback data, such as status information of the fan-speed control devices) from the fan-speed control devices via the communication circuit 514.

The processing device 500 may further comprise a user interface circuit 516. The user interface circuit 516 may comprise one or more input circuits for receiving inputs. For example, the user interface circuit 516 may comprise one or more actuators configured to be actuated in response to actuation of one or more respective buttons of the processing device 500. In addition, the user interface circuit 516 may comprise a touch sensitive circuit (e.g., a capacitive or resistive touch element) that may be responsive to actuations (e.g., touch actuations) of a touch sensitive surface of the processing device 500 (e.g., a touch screen). Further, the user interface circuit 516 may comprise one or more light sources configured to illuminate visual indicators of the processing device 500 for providing feedback information to a user. In some examples, the user interface circuit 516 may comprise a visual display.

The control circuit 510 may be configured to configure a fan-speed control device in response to user inputs received via the user interface circuit 516. For example, the control circuit 510 may be configured to set each of a total number N_{PRE-TOT} of preset speeds S_{PRE-1}-S_{PRE-4} of the fan-speed control device to one of a total number N_{POS-TOT} of possible speeds S_{POS-1}-S_{POS-7}. For example, the control circuit may receive an indication of a selected preset speed S_{PRE-SEL} to configure and/or a selected possible speed S_{POS-SEL} to which to set the selected preset speed S_{PRE-SEL} in response to an actuation of a graphical user interface (GUI) displayed on a visible display of the user interface circuit 516 of the processing device 500. The control circuit 510 may be configured to display, for example, the screen 200 and/or the screen 250 on the visible display. The control circuit 510 may receive the indication of the selected preset speed S_{PRE-SEL} to configure, for example, in response to an actuation of the arrow actuator 214 of the low preset speed pull-down menu 212, the arrow actuator 224 of the medium-low preset speed pull-down menu 222, the arrow actuator 234 of the medium-high preset speed pull-down menu 232, and/or the arrow actuator 244 of the high preset speed pull-down menu 242. In some examples, the control circuit 510 may receive the indication of the selected preset speed S_{PRE-SEL} to configure, for example, in response to an actuation of one of the low preset speed indicator 262, the medium-low preset speed indicator 272, the medium-high preset speed indicator 282, or the high preset speed indicator 292. The control circuit 510 may receive the indication of the selected possible speed S_{POS-SEL} to which to set the selected preset speed S_{PRE-SEL}, for example, in response to a selection of one of the possible speed indicators 218 in the possible speed selection list 216 of the low preset speed pull-down menu 212, one of the possible speed indicators 228 in the possible speed selection list 226 of the medium-low preset speed pull-down menu 222, one of the possible speed indicators 238 in the possible speed selection list 236 of the medium-high preset speed pull-down menu 232, and/or one of the possible speed indicators 248 in the possible speed selection list 246 of the high preset speed pull-down menu 242). In some examples, the control circuit 510 may receive the indication of the selected possible speed S_{POS-SEL} to which to set the selected preset speed S_{PRE-SEL}, for example, in response to a selected preset speed indicator of the screen 250 being located over one of the possible speed indicators 255 of the slider selection tool 252.

The control circuit 510 may be configured to store the configuration data (e.g., to store the selected possible speed S_{POS-SEL} as the selected preset speed S_{PRE-SEL}) in the memory 512. The control circuit 510 may be configured to store the selected preset speed S_{PRE-SEL} and the selected possible speed S_{POS-SEL} in the memory 512 as, for example, integer values. For example, the control circuit 510 may be configured to store the selected preset speed S_{PRE-SEL} and the selected possible speed S_{POS-SEL} in the memory 512 as a selected preset speed number N_{PRE-SEL} (e.g., which may range from 1 to 4) and a selected possible speed number N_{POS-SEL} (e.g., which may range from 1 to 7), respectively.

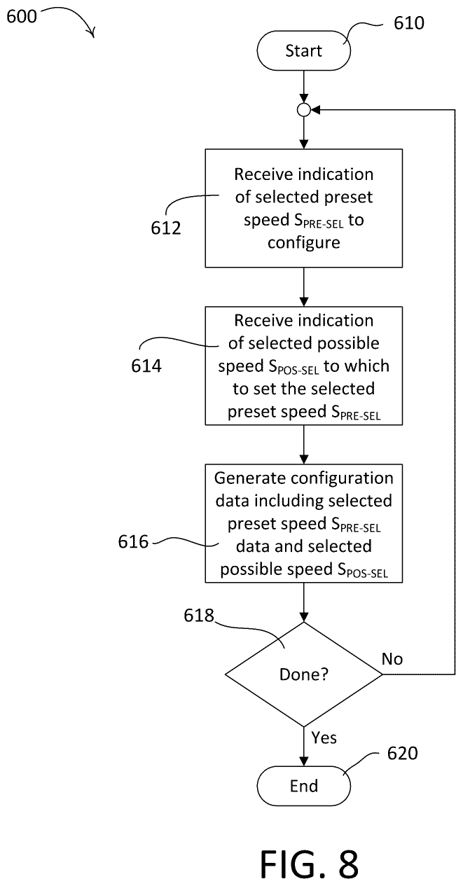

FIG. 8 is a flowchart of an example procedure 600 that may be executed by a control device (e.g., the fan-speed control devices 120, 130, the system controller 150, and/or the network device 160 of the load control system 100, the fan-speed control devices 300, 400, and/or the processing device 500) to configure a fan-speed control device (e.g., the fan-speed control devices 120, 130, 300, 400). The procedure 600 may be executed by a control circuit of the control device (e.g., control circuits of the fan-speed control devices 120, 130, 300, control circuits of the system controller 150 and/or the network device 160, the control circuit 420 of the control device 400, and/or the control circuit 510 of the processing device 500) to set one or more of a total number N_{PRE-TOT} of preset speeds S_{PRE-1}-S_{PRE-7} to one of a total number N_{POS-TOT} of possible speeds S_{POS-1}-S_{POS-7} of the fan-speed control device. For example, the control circuit may execute the procedure 600 at 610 in response to entering a configuration mode (e.g., the advanced programming mode of the fan-speed control device 420), in response to receiving user inputs via a user interface of the control device, and/or in response to receiving a message including configuration data via a communication circuit.

At 612, the control circuit may receive an indication of a selected preset speed S_{PRE-SEL} to configure. For example, the control circuit may receive the indication of the selected preset speed S_{PRE-SEL} in a message received via the communication circuit (e.g., from the system controller 150 and/or the network device 160). In addition, the control circuit may receive the indication of the selected preset speed S_{PRE-SEL} in response to actuations of one or more buttons and/or touch actuations of a touch sensitive surface of the user interface when operating in the advanced programming mode. For example, the fan-speed control device 300 may be configured to adjust the illumination of the light bar 320 to indicate the one of the preset speeds S_{PRE-1}-S_{PRE-4} to be configured in response to a touch actuation of the front surface 315 of the actuation member 310 along the light bar 320, and may receive the indication of the selected preset speed S_{PRE-SEL} in response to an actuation of the lower portion 318 of the actuation member 310. Further, the control circuit may receive the indication of the selected preset speed S_{PRE-SEL} in response to an actuation of a graphical user interface (GUI) displayed on a visible display of the user interface of the control device. For example, a control circuit of a network device may display the screen 200 on a visible display and may receive the indication of the selected preset speed S_{PRE-SEL} in response to an actuation of the arrow actuator 214 of the low preset speed pull-down menu 212, the arrow actuator 224 of the medium-low preset speed pull-down menu 222, the arrow actuator 234 of the medium-high preset speed pull-down menu 232, and/or the arrow actuator 244 of the high preset speed pull-down menu 242. In some examples, a control circuit of a network device may display the screen 250 on a visible display and may receive the indication of the selected preset speed S_{PRE-SEL} in response to an actuation of one of the low preset speed indicator 262, the medium-low preset speed indicator 272, the medium-high preset speed indicator 282, or the high preset speed indicator 292.

At 614, the control circuit may receive an indication of a selected possible speed S_{POS-SEL} to which to set the selected preset speed S_{PRE-SEL}. For example, the control circuit may receive the indication of the selected possible speed S_{POS-SEL} in a message received via the communication circuit (e.g., from the system controller 150 and/or the network device 160). In addition, the control circuit may receive the indication of the selected preset speed S_{PRE-SEL} in response to actuations of one or more buttons and/or touch actuations of a touch sensitive surface of the user interface when operating in the advanced programming mode. For example, the fan-speed control device 300 may be configured to adjust the illumination of the light bar 320 to indicate the one of the possible speeds S_{POS-1}-S_{POS-7} to be configured in response to a touch actuation of the front surface 315 of the actuation member 310 along the light bar 320, and may receive the indication of the selected possible speed S_{POS-SEL} in response to an actuation of the lower portion 318 of the actuation member 310. Further, the control circuit may receive the indication of the selected possible speed S_{POS-SEL} in response to an actuation of the graphical user interface displayed on the visible display of the user interface of the control device. For example, a control circuit of a network device may display the screen 200 on a visible display and may receive the indication of the selected possible speed S_{POS-SEL} in response to a selection of one of the possible speed indicators 218 in the possible speed selection list 216 of the low preset speed pull-down menu 212, one of the possible speed indicators 228 in the possible speed selection list 226 of the medium-low preset speed pull-down menu 222, one of the possible speed indicators 238 in the possible speed selection list 236 of the medium-high preset speed pull-down menu 232, and/or one of the possible speed indicators 248 in the possible speed selection list 246 of the high preset speed pull-down menu 242. In addition, the control circuit may be configured to receive the indication of the selected possible speed S_{POS-SEL} in response to an actuation of a selection object (e.g., a checkbox, a radio button, and/or a switch) next to each of the possible speed indicators 218 in the possible speed selection list 216, each of the possible speed indicators 228 in the possible speed selection list 226, each of the possible speed indicators 238 in the possible speed selection list 236, and/or each of the possible speed indicators 248 in the possible speed selection list 246. In some examples, a control circuit of a network device may display the screen 250 on a visible display and may receive the indication of the selected possible speed S_{POS-SEL} in response to a selected preset speed indicator being located over one of the possible speed indicators 255 of the slider selection tool 252. In some examples, the control circuit may be configured to receive, at 614, an indication of the selected possible speed S_{POS-SEL} that is not limited to the possible speeds S_{POS-1}-S_{POS-7} (e.g., the discrete possible speeds). For example, the control circuit may be configured to adjust (e.g., continuously adjust) the rotational speed S_{FAN} (e.g., the possible speed) of the ceiling fan to adjust between the minimum speed (e.g., the first possible speed S_{POS-1}) and the maximum speed (e.g., the seventh possible speed S_{POS-7}). The control circuit may be configured to continuously adjust the rotational speed S_{FAN} of the ceiling fan using, for example, a phase-control power-limiting (e.g., dimming) technique (e.g., a forward phase-control technique and/or a reverse phase-control technique).

At 616, the control circuit may generate configuration data (e.g., preset configuration data) that includes the selected preset speed S_{PRE-SEL} (e.g., as received at 612) and the selected possible speed S_{POS-SEL} (e.g., as received at 614). For example, the control circuit may be configured to store the configuration data (e.g., the selected preset speed S_{PRE-SEL} and the selected possible speed S_{POS-SEL}) in memory (e.g., the memory 424, 512) at 616. The control circuit may be configured to store the selected preset speed S_{PRE-SEL} and the selected possible speed S_{POS-SEL} in memory as, for example, integer values. For example, the control circuit may be configured to store the selected preset speed S_{PRE-SEL} and the selected possible speed S_{POS-SEL} in memory as a selected preset speed number N_{PRE-SEL} (e.g., which may range from 1 to 4) and a selected possible speed number N_{POS-SEL} (e.g., which may range from 1 to 7), respectively. In some examples, the control circuit may be configured to transmit one or more messages including the configuration data (e.g., the selected preset speed S_{PRE-SEL} and the selected possible speed S_{POS-SEL}) to the fan-speed control device at 616 (e.g., when the procedure 600 is performed by the system controller 150 and/or the network device 160, the system controller 150 and/or the network device 160 may transmit the configuration data to the fan-speed control devices 120, 130). If the control circuit is not done configuring the preset speeds S_{PRE-1}-S_{PRE-4} (e.g., if there are other one of the preset speeds S_{PRE-1}-S_{PRE-4} to configure) at 618, the control circuit may receive an indication of another selected preset speed S_{PRE-SEL} to configure at 612 and receive an indication of a selected possible speed S_{POS-SEL} to which to set the selected preset speed S_{PRE-SEL} at 614. When the control circuit is done configuring the preset speeds S_{PRE-1}-S_{PRE-4} at 618, the procedure 600 may end at 620.

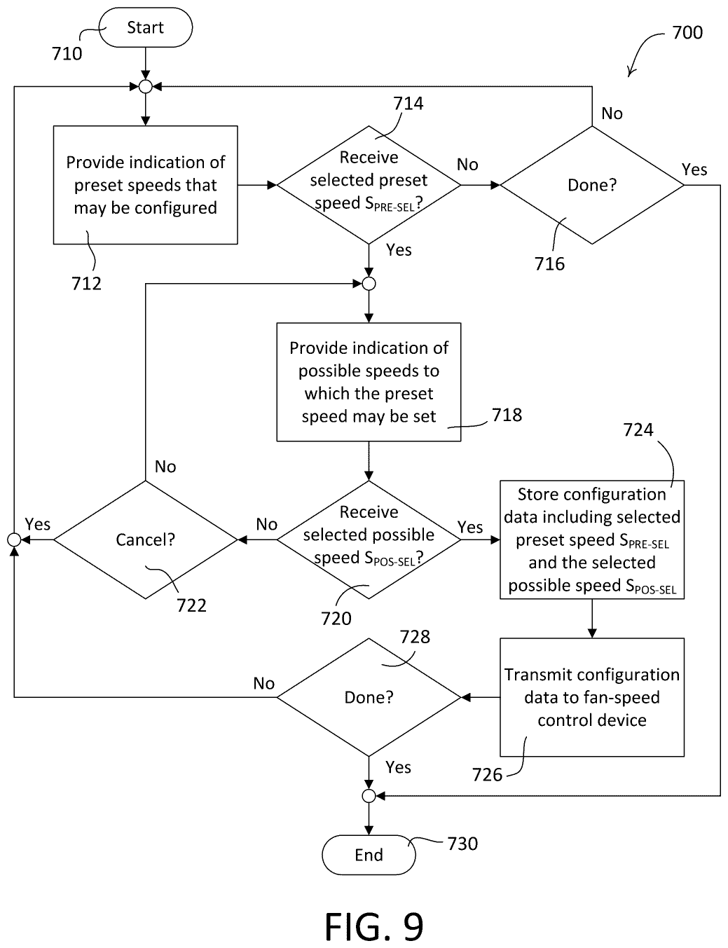

FIG. 9 is a flowchart of an example procedure 700 that may be executed by a processing device (e.g., the system controller 150, and/or the network device 160 of the load control system 100, and/or the processing device 500) to configure a fan-speed control device (e.g., the fan-speed control devices 120, 130, 300, 400). The procedure 700 may be executed by a control circuit of the processing device (e.g., control circuits of the system controller 150 and/or the network device 160, and/or the control circuit 510 of the processing device 500) to set one or more of a total number N_{PRE-TOT} of preset speeds S_{PRE-1}-S_{PRE-4} to one of a total number N_{POS-TOT} of possible speeds S_{POS-1}-S_{POS-7} of the fan-speed control device. For example, the control circuit may execute the procedure 700 at 710 in response to receiving user inputs via a user interface of the processing device (e.g., from a user via a graphical user interface displayed on a visible display).

At 712, the control circuit may provide an indication of the preset speeds S_{PRE-1}-S_{PRE-4} that may be configured (e.g., on the visible display). For example, the control circuit may display the screen 200 that includes the low preset speed selection portion 210 (e.g., for setting the first preset speed S_{PRE-1}), the medium-low preset speed selection portion 220 (e.g., for setting the second preset speed S_{PRE-2}), the medium-high preset speed selection portion 230 (e.g., for setting the third preset speed S_{PRE-3}), and the high preset speed selection portion 240 (e.g., for setting the fourth preset speed S_{PRE-4}). At 714, the control circuit may determine if an indication of the selected preset speed S_{PRE-SEL} has been received. For example, the control circuit may receive the indication of the selected preset speed S_{PRE-SEL} in response to an actuation of the arrow actuator 214 of the low preset speed pull-down menu 212, the arrow actuator 224 of the medium-low preset speed pull-down menu 222, the arrow actuator 234 of the medium-high preset speed pull-down menu 232, and/or the arrow actuator 244 of the high preset speed pull-down menu 242. If the indication of the selected preset speed S_{PRE-SEL} has not been received at 714 and the user is not done configuring the fan-speed control device at 716, the control circuit may continue to provide the indication of the preset speeds S_{PRE-1}-S_{PRE-4} that may be configured at 712. If the indication of the selected preset speed S_{PRE-SEL} has not been received at 714 and the user is done configuring the fan-speed control device at 716, the procedure 700 may end at 730.

When the indication of the selected preset speed S_{PRE-SEL} has been received at 714, the control circuit may provide an indication of the possible speeds S_{POS-1}-S_{POS-7} to which the selected preset speed S_{PRE-SEL} may be set at 718. For example, the control circuit may display the possible speed indicators 218 in the possible speed selection list 216 of the low preset speed pull-down menu 212, the possible speed indicators 228 in the possible speed selection list 326 of the medium-low preset speed pull-down menu 222, the possible speed indicators 238 in the possible speed selection list 236 of the medium-high preset speed pull-down menu 232, and/or the possible speed indicators 248 in the possible speed selection list 246 of the high preset speed pull-down menu 242. At 718, the control circuit may be configured to limit the possible speed indicators 218, 228, 238, 248 that are displayed in each of the respective possible speed selection lists 216, 226, 236, 246 for one of the preset speeds S_{PRE-1}-S_{PRE-4}, such that the preset speeds S_{PRE-1}-S_{PRE-4} may increase in speed in order and each of the possible speeds S_{POS-1}-S_{POS-7} may only be set to one of the preset speeds S_{PRE-1}-S_{PRE-4}. In addition, the control circuit may be configured to limit the possible speed indicators 218, 228, 238, 248 that are displayed based on any of the possible speeds S_{POS-1}-S_{POS-7} that are already assigned to any of the other preset speeds S_{PRE-1}-S_{PRE-4}.

At 720, the control circuit may determine if an indication of the selected possible speed S_{POS-SEL} has been received. For example, the control circuit may receive the indication of the selected possible speed S_{POS-SEL} in response to a selection of one of the possible speed indicators 218 in the possible speed selection list 216 of the low preset speed pull-down menu 212, one of the possible speed indicators 228 in the possible speed selection list 226 of the medium-low preset speed pull-down menu 222, one of the possible speed indicators 238 in the possible speed selection list 236 of the medium-high preset speed pull-down menu 232, and/or one of the possible speed indicators 248 in the possible speed selection list 246 of the high preset speed pull-down menu 242. If the indication of the selected preset speed S_{PRE-SEL} has not been received at 720, the control circuit may determine if the user had decided to cancel configuring the selected preset speed S_{PRE-SEL} at 722. If the user has not decided to cancel configuring the selected preset speed S_{PRE-SEL} at 722, the control circuit may continue to provide the indication of the possible speeds S_{POS-1}-S_{POS-7} to which the selected preset speed S_{PRE-SEL} may be set at 718. If the user had decided to cancel configuring the selected preset speed S_{PRE-SEL} at 722, the control circuit may once again provide the indication of the preset speeds S_{PRE-1}-S_{PRE-4} that may be configured at 712.

When the indication of the selected possible speed S_{POS-SEL} has been received at 720, the control circuit may at 724 generate and store configuration data (e.g., preset configuration data) that includes the selected preset speed S_{PRE-SEL} (e.g., as received at 714) and the selected possible speed S_{POS-SEL} (e.g., as received at 720). The control circuit may be configured to store the selected preset speed S_{PRE-SEL} and the selected possible speed S_{POS-SEL} in memory as, for example, integer values. For example, the control circuit may be configured to store the selected preset speed S_{PRE-SEL} and the selected possible speed S_{POS-SEL} in memory as a selected preset speed number N_{PRE-SEL} (e.g., which may range from 1 to 4) and a selected possible speed number N_{POS-SEL} (e.g., which may range from 1 to 7), respectively. At 726, the control circuit may transmit the configuration data to the fan-speed control device (e.g., via the communication circuit 514). If the user is not done configuring the fan-speed control device at 728, the control circuit may once again provide the indication of the preset speeds S_{PRE-1}-S_{PRE-4} that may be configured at 712 (e.g., to allow for configuration of another one of the preset speeds S_{PRE-1}-S_{PRE-4}). When the user is done configuring the fan-speed control device at 728, the procedure 700 by end at 730.

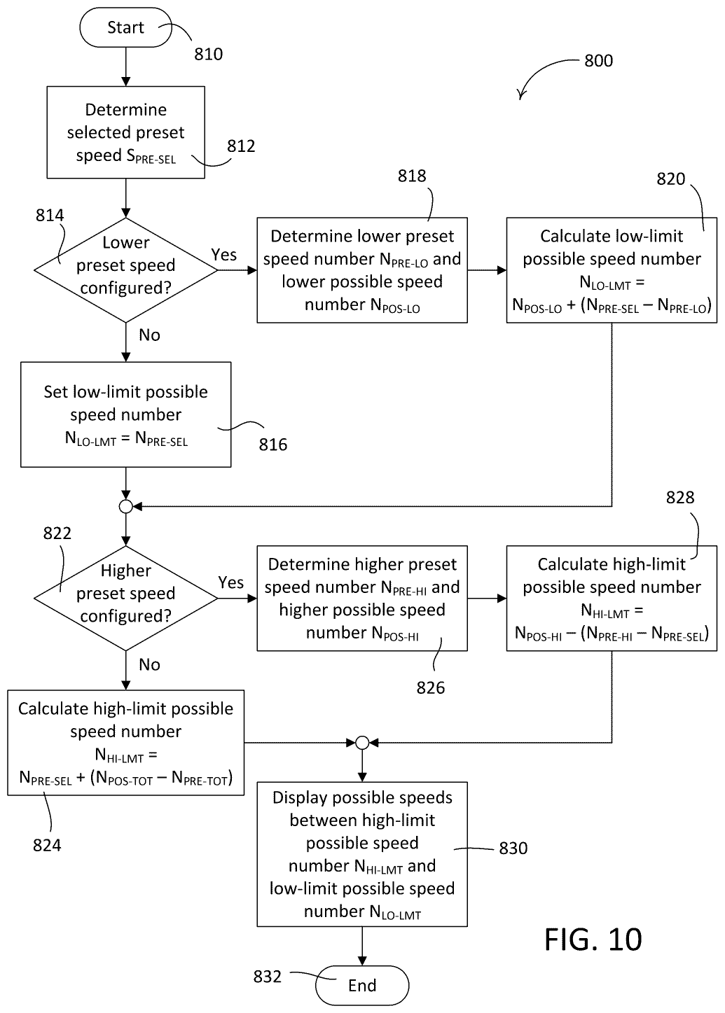

FIG. 10 is a flowchart of an example procedure 800 that may be executed by a processing device (e.g., the system controller 150, and/or the network device 160 of the load control system 100, and/or the processing device 500) to configure a fan-speed control device (e.g., the fan-speed control devices 120, 130, 300, 400). The procedure 800 may be executed by a control circuit of the processing device (e.g., control circuits of the system controller 150 and/or the network device 160, and/or the control circuit 510 of the processing device 500) for display one or more possible speed indicators (e.g., the possible speed indicators 218, 228, 238, 248) for a selected preset speed S_{PRE-SEL}. The procedure 800 may be executed during a configuration procedure for setting one or more of a total number N_{PRE-TOT} of preset speeds S_{PRE-1}-S_{PRE-4} to one of a total number N_{POS-TOT} of possible speeds S_{POS-1}-S_{POS-7} of a fan-speed control device (e.g., at 718 of the procedure 700). For example, the control circuit may be configured to determine which of the possible speed indicators to display, such that, after configuration of the preset speeds S_{PRE-1}-S_{PRE-4} of the fan-speed device, the preset speeds S_{PRE-1}-S_{PRE-4} may increase in speed in order and each of the possible speeds S_{POS-1}-S_{POS-7} may only be set to one of the preset speeds S_{PRE-1}-S_{PRE-4}. In addition, the control circuit may be configured to limit the possible speed indicators that are displayed based on any of the possible speeds S_{POS-1}-S_{POS-7} that are already assigned to any of the other preset speeds S_{PRE-1}-S_{PRE-4}. During the procedure 800, the control circuit may be configured to set a low-limit possible speed number N_{LO-LMT} and a high-limit possible speed number N_{HI-LMT} that define a range of the possible speed indicators to display. For example, the control circuit may execute the procedure 800 at 810 during the configuration procedure (e.g., at 718 of the procedure 700).

At 812, the control circuit may determine the selected preset speed S_{PRE-SEL} (e.g., as received at 714 of the procedure 700). For example, the selected preset speed S_{PRE-SEL} may be represented by a selected preset speed number N_{PRE-SEL}. At 814, the control circuit may determine if any of the preset speeds that are lower than the selected preset speed S_{PRE-SEL} have already been configured (e.g., set to one of the possible speeds). If the selected preset speed S_{PRE-SEL} is the lowest preset speed (e.g., the first preset speed S_{PRE-1}), the control circuit may determine that there are not any preset speeds that are lower than the selected preset speed S_{PRE-SEL} have already been configured at 814. If none of the preset speeds that are lower than the selected preset speed S_{PRE-SEL} have already been configured at 814, the control circuit may be configured to set (e.g., calculate) the low-limit possible speed number N_{LO-LMT} at 816. For example, the control circuit may be configured to set the low-limit possible speed number N_{LO-LMT} equal to the selected preset speed number N_{PRE-SEL}. If any of the preset speeds that are lower than the selected preset speed S_{PRE-SEL} have already been configured at 814, the control circuit may determine, at 818, a lower preset speed number N_{PRE-LO} that represents the preset speed that is closest to the selected preset speed S_{PRE-SEL} and below the selected preset speed S_{PRE-SEL} and a lower possible speed number N_{POS-LO} that represents the possible speed to which the preset speed having the lower preset speed number N_{PRE-LO} is set. At 820, the control circuit may set (e.g., calculate) the low-limit possible speed number N_{LO-LMT} based on the selected preset speed number N_{PRE-SEL}, the lower preset speed number N_{PRE-LO}, and the lower possible speed number N_{POS-LO}. For example, the control circuit may set the low-limit possible speed number N_{LO-LMT} equal to the lower possible speed number N_{POS-LO} plus the difference between the selected preset speed S_{PRE-SEL} and the lower preset speed number N_{PRE-LO}, e.g.,

$${N}_{LO - LMT} = {N}_{POS - LO} + ( {N}_{PRE - SEL} - {N}_{PRE - LO} ) .$$

The low-limit possible speed number N_{LO-LMT} may set a lower bound of the range of the possible speed indicators that may be displayed by the network device.

After setting the setting the low-limit possible speed number N_{LO-LMT} at 816 or 820, the control circuit may determine at 822 if any of the preset speeds that are higher than the selected preset speed S_{PRE-SEL} have already been configured (e.g., set to one of the possible speeds). If the selected preset speed S_{PRE-SEL} is the highest preset speed (e.g., the fourth preset speed S_{PRE-4}), the control circuit may determine that there are not any preset speeds that are higher than the selected preset speed S_{PRE-SEL} have already been configured at 822. If none of the preset speeds that are higher than the selected preset speed S_{PRE-SEL} have already been configured at 822, the control circuit may be configured to set (e.g., calculate) the high-limit possible speed number N_{HI-LMT} at 824. For example, the control circuit may be configured to set the high-limit possible speed number N_{HI-LMT} equal to the selected preset speed number N_{PRE-SEL} plus the difference between the total number N_{POS-TOT} and the total number N_{PRE-TOT}, e.g.,

$${N}_{HI - LMT} = {N}_{PRE - SEL} + ( {N}_{POS - TOT} - {N}_{PRE - TOT} ) .$$

If any of the preset speeds that are higher than the selected preset speed S_{PRE-SEL} have already been configured at 822, the control circuit may determine, at 826, a higher preset speed number N_{PRE-HI} that represents the preset speed that is closest to the selected preset speed S_{PRE-SEL} and above the selected preset speed S_{PRE-SEL} and a higher possible speed number N_{POS-HI} that represents the possible speed to which the preset speed having the higher preset speed number N_{PRE-HI} is set. At 828, the control circuit may set (e.g., calculate) the high-limit possible speed number N_{HI-LMT} based on the selected preset speed number N_{PRE-SEL}, the higher preset speed number N_{PRE-HI}, and the higher possible speed number N_{POS-HI}. For example, the control circuit may set the high-limit possible speed number N_{HI-LMT} equal to the higher possible speed number N_{POS-HI} minus the difference between the higher preset speed number N_{PRE-LO} and the selected preset speed S_{PRE-SEL}, e.g.,

$${N}_{HI - LMT} = {N}_{POS - HI} - ( {N}_{PRE - HI} - {N}_{PRE - SEL} ) .$$

The high-limit possible speed number N_{HI-LMT} may set an upper bound of the range of the possible speed indicators that may be displayed by the network device.

After setting the setting the high-limit possible speed number N_{HI-LMT} at 824 or 828, the control circuit may display at 830 the possible speed indicators for those of the possible speeds S_{POS-1}-S_{POS-7} between the low-limit possible speed number N_{LO-LMT} and the high-limit possible speed number N_{HI-LMT}, before the procedure 800 ends at 832. In some examples, the control circuit may at 830 display the possible speed indicators for those of the possible speeds S_{POS-1}-S_{POS-7} that are between the low-limit possible speed number N_{LO-LMT} and the high-limit possible speed number N_{HI-LMT} in dark text and may display the possible speed indicators for those of the possible speeds S_{POS-1}-S_{POS-7} that are not between the low-limit possible speed number N_{LO-LMT} and the high-limit possible speed number N_{HI-LMT} in gray text. In addition, for the respective possible speed indicators that are displayed in gray text, the control circuit may display one of the preset speeds S_{PRE-1}-S_{PRE-4} to which the respective possible speed S_{POS-1}-S_{POS-7} is assigned (e.g., next to the respective possible speed indicator).

Although described as being performed by a processing device, in some examples, a control device (e.g., a control circuit of the load control device 120, a control circuit of the load control device 130, a control circuit of the control device 300, and/or the control circuit 420 of the control device 400) may perform the procedure 800 to illuminate one or more illuminated portions of a light bar of the control device (e.g., the illuminated portions 321a, 322a, 323a, 324a or the illuminated portions 321b, 322b, 323b, 324b of the light bar 320) to indicate one or more possible speed indicators for a selected preset speed S_{PRE-SEL}.

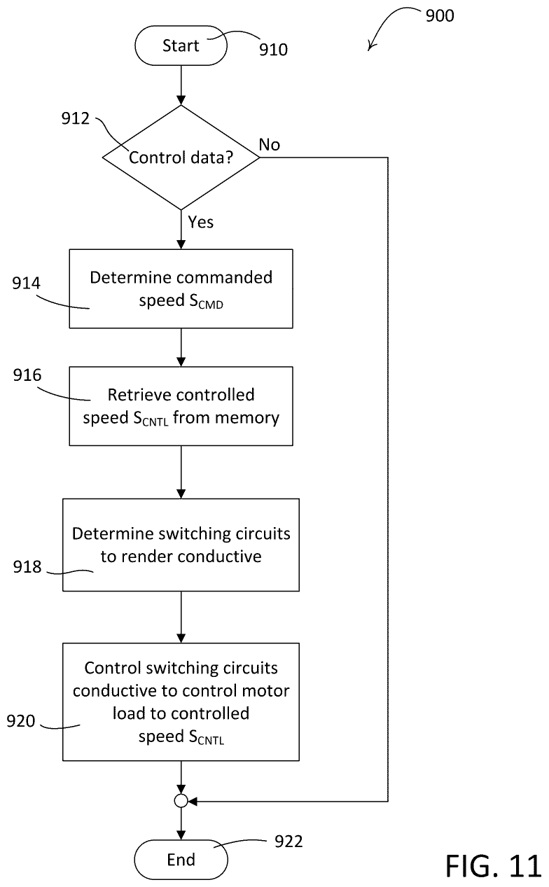

FIG. 11 is a flowchart of an example control procedure 900 to adjust a rotational speed S_{MOTOR} of a motor load (e.g., the motor 112a of the ceiling fan 110a, the motor 112b of the motor 110b, and/or the motor load 404). The control procedure 900 may be executed by a control circuit of a fan-speed control device (e.g., a control circuit of the first fan-speed control device 120, a control circuit of the second fan-speed control device 130, a control circuit of the fan-speed control device 300, and/or the control circuit 420 of the fan-speed control device 400). The fan-speed control device may comprise a motor load control circuit (e.g., the motor load control circuit 410) having a plurality of controllable switching circuits (e.g., the controllable switching circuits 412a-412d) that may be controlled by the control circuit to control the rotational speed S_{MOTOR} of the motor load. For example, the control circuit may execute the control procedure 900 in response to the reception of a command received by the fan-speed control device. The control circuit may execute the control procedure 900 at 910 periodically, and/or in response to receiving a command to adjust the rotational speed S_{MOTOR} of the motor load.

At 912, the control circuit may determine whether it receives control data (e.g., one or more commands) to adjust the rotational speed S_{MOTOR} of the motor load. The control circuit may, for example, receive control data (e.g., one or more commands) from a user interface (e.g., the user interface of the first fan-speed control device 120, the user interface of the second fan-speed control device 130, the GUI displayed by the network device 160, and/or the user interface 320 of the fan-speed control device 300). For example, the control circuit may detect a touch actuation of the touch sensitive surface on a front surface of an actuation member (e.g., the front surface 315 of the actuation member 310) that corresponds to a command to adjust the rotational speed S_{MOTOR} of the motor load. For instance, as noted herein, the control circuit may be configured to control the rotational speed S_{FAN} of the motor load to one of the preset speeds S_{PRE-4}-S_{PRE-4} based on the position of the touch actuation (e.g., a touch input) along the touch sensitive surface of the actuation member. Alternatively or additionally, the control circuit may be configured to receive one or more messages that include control data (e.g., one or more commands) for controlling the motor load via a communication circuit (e.g., the communication circuit 426) of the fan-speed control device. For instance, the control circuit may be configured to control the rotational speed S_{FAN} of the motor load to one of the preset speeds S_{PRE-1}-S_{PRE-4} in response to the control data included in the one or more messages. If the control circuit determines that control data has not been received at 912, the procedure 900 may end 922.

If the control circuit determines that control data is received at 912, the control circuit may determine the commanded speed at 914, for example, based on the control data (e.g., the one or more commands). The commanded speed SC_{MD} may, for example, be a commanded speed number N_{PRE-CMD} (e.g., an integer value) that may represent one of a number N_{PRE} of preset speeds (e.g., the preset speeds S_{PRE-1}-S_{PRE-4}). For example, if the control data (e.g., command) was received via a touch actuation (e.g., if a touch actuation is presently occurring at 912), the control circuit may determine a position of the touch actuation on the touch sensitive surface along a light bar (e.g., the light bar 320). The control circuit may determine a commanded speed S_{CMD} in response to the position of the touch actuation on the touch sensitive surface along the light bar. For example, the control circuit may set the commanded speed S_{CMD} (e.g., the commanded speed number N_{PRE-CMD}) equal to a first preset speed number N_{PRE-1} (e.g., the integer 1 to represent the first preset speed S_{PRE-1}) when the position of the touch actuation along the light bar is within a first region (e.g., the first region 311), equal to a second preset speed number N_{PRE-2} (e.g., the integer 2 to represent the second preset speed S_{PRE-2}) when the position of the touch actuation along the light bar is within a second region (e.g., the second region 312), equal to a third preset speed number N_{PRE-3} (e.g., the integer 3 to represent the third preset speed S_{PRE-3}) when the position of the touch actuation along the light bar is within a third region (e.g., the third region 313), and equal to a fourth preset speed number N_{PRE-4} (e.g., the integer 4 to represent the fourth preset speed S_{PRE-4}) when the position of the touch actuation along the light bar is within a fourth region (e.g., the fourth region 314). Alternatively or additionally, if the control data (e.g., command) was received via one or more messages, the control circuit may be configured to determine the commanded speed S_{CMD} in response to the control data included in the one or more messages.

At 916, the control circuit may retrieve a controlled speed S_{CNTL} from memory in response to the commanded speed S_{CMD} (e.g., the one of the preset speeds S_{PRE-1}-S_{PRE-4} represented by the controlled speed number N_{PRE-CMD} determined at 914). For example, the controlled speed S_{CTNL} may be a controlled speed number N_{POS-CNTL (}e.g., an integer value) that may represent one of a total number N_{POS-TOT} of possible speeds S_{POS-1}-S_{POS-7} to which the fan-speed control device may be configured to control the motor load. For example, the possible speeds S_{POS-1}-S_{POS-7} may be represented by respective possible speed numbers N_{POS-1}-N_{POS-7}. The fan-speed control device may have stored in memory one of the possible speed numbers N_{POS-1}-N_{POS-7} for each of the preset speeds S_{PRE-1}-S_{PRE-4} (e.g., as presented by the preset speed numbers N_{PRE-1}-N_{PRE-4}). In some examples, when the control circuit is capable of continuously adjusting the rotational speed S_{FAN} of the ceiling fan, the commanded speed S_{CMD} may range between the first possible speed S_{POS-1} and the seventh possible speed S_{POS-7}. For example, the commanded speed S_{CMD} may indicate a control time for controlling one of the controllable switching circuits of the motor control circuit using a phase-control power-limiting technique.

After retrieving the controlled speed S_{CNTL} (e.g., the controlled speed number N_{PRE-CMD}) from memory at 916, the control circuit may determine which of the plurality of controllable switching circuits of the motor control circuit to render conductive and/or non-conductive at 918. For example, for each of the total number N_{POS-TOT} of possible speeds S_{POS-1}-S_{POS-7} to which the fan-speed control device may be configured to control the motor load, there may be a unique combination of capacitors that may be coupled in series with the motor load (e.g., a unique combination of the capacitors C414a-C414c). The controllable switching circuits of the motor control circuit to be rendered conductive and/or non-conductive for each of the possible speeds S_{POS-1}-S_{POS-7} may be stored in memory. In some examples, when the control circuit is capable of continuously adjusting the rotational speed S_{FAN} of the ceiling fan, the control circuit may be configured to determine to render all except for one of the controllable switching circuits (e.g., the controllable switching circuits non-conductive at 412a, 412b, 412c) non-conductive at 918.

At 920, the control circuit may control the controllable switching circuits of the motor control circuit to control the motor load to the controlled speed S_{CNTL}, before the procedure 900 ends at 922. For example, the control circuit may render the controllable switching circuits conductive and non-conductive based on the determination at 918. In some examples, when the control circuit is capable of continuously adjusting the rotational speed S_{FAN} of the ceiling fan, the control circuit may be configured to render all except for one of the controllable switching circuits (e.g., the controllable switching circuits 412a, 412b, 412c) non-conductive and control the other controllably conductive switching circuit (e.g., the controllable switching circuit 414d) based on the determined control time using the phase-control power-limiting technique at 920.

What is claimed is:

1. A method for configuring a load control device configured to control a motor load, the method comprising:
receiving an indication of a selected preset speed to configure, the selected preset speed being one of a number of discrete preset speeds to which the load control device can control a rotational speed of the motor load in response to receiving an input;
receiving an indication of a selected possible speed to which to set the selected preset speed, the selected possible speed being one of a number of discrete possible speeds to which a motor control circuit of the load control device can control the motor load; and
storing configuration data comprising the selected preset speed and the selected possible speed, the configuration data being configured to allow the load control device to control the motor load to the selected possible speed when the input indicates the selected preset speed.

2. The method of claim 1, wherein receiving the indication of the selected preset speed to configure further comprises receiving the indication of the selected preset speed using a graphical user interface displayed on a visible display, and receiving the indication of the selected possible speed to which to set the selected preset speed further comprises receiving the indication of the selected possible speed using the graphical user interface displayed on the visible display.

3. The method of claim 2, further comprising:
displaying the discrete preset speeds on the visible display; and
receiving a selection of one of the discrete preset speeds displayed on the visible display.

4. The method of claim 3, further comprising setting a low-limit possible speed number and a high-limit possible speed number that together define a range of the discrete possible speeds to display on the visible display.

5. The method of claim 4, wherein the low-limit possible speed number is equal to a number of the selected preset speed, and the high-limit possible speed number is equal to the number of the selected preset speed plus a difference between a number of discrete possible speeds and the number of the discrete preset speeds.

6. The method of claim 4, further comprising:
determining that one of the preset speeds that is lower than the selected preset speed has been previously configured, wherein the one of the preset speeds that is lower than the selected preset speed is indicated by a lower preset speed number and is set to one of the discrete possible speeds that is indicated by a lower possible speed number;
wherein the low-limit possible speed number is equal to a lower possible speed number plus a difference between a number of the selected preset speed and the lower preset speed number.

7. The method of claim 4, further comprising:
determining that one of the preset speeds that is higher than the selected preset speed has been previously configured, wherein the one of the preset speeds that is higher than the selected preset speed is indicated by a higher preset speed number and is set to one of the discrete possible speeds that is indicated by a higher possible speed number;
wherein the high-limit possible speed number is equal to a higher possible speed number minus a difference between the higher preset speed number and a number of the selected preset speed.

8. The method of claim 3, further comprising:
limiting the number of the discrete possible speeds displayed on the visible display.

9. The method of claim 8, wherein limiting the number of the discrete possible displayed on the visible display further comprises limiting the number of the discrete possible speeds displayed on the visible display to ensure that the preset speeds increase in speed in order.

10. The method of claim 3, further comprising:
limiting the number of the discrete possible speeds displayed on the visible display based on a prior selection of one of the discrete possible speeds for one of the other discrete preset speeds.

11. The method of claim 3, wherein receiving the selection of one of the discrete preset speeds displayed on the visible display further comprises detecting a selection of an indicator of one of the discrete possible speeds in a pull-down menu.

12. The method of claim 3, wherein receiving the selection of one of the discrete preset speeds displayed on the visible display further comprises detecting an actuation of a selection object next to each of the discrete possible speeds displayed on the visible display.

13. The method of claim 2, further comprising:
displaying the discrete possible speeds on the visible display in response to receiving the selection of one of the discrete preset speeds displayed on the visible display; and
receiving a selection of one of the discrete possible speeds displayed on the visible display.

14. The method of claim 13, wherein receiving the selection of one of the discrete preset speeds displayed on the visible display further comprises receiving the selection of one of the discrete preset speeds in response to an actuation of an arrow actuator of a pull-down menu.

15. The method of claim 1, further comprising:
receiving the input indicating the selected preset speed; and
controlling the motor load to the selected possible speed in response to receiving an input indicating the selected preset speed.

16. The method of claim 15, wherein receiving the indication of the selected preset speed to configure further comprises receiving the indication of the selected preset speed in one or more messages received via a communication circuit, and receiving the indication of the selected possible speed to which to set the selected preset speed further comprises receiving the indication of the selected possible speeds in one or more messages received via the communication circuit.

17. The method of claim 16, further comprising:
storing the configuration data in memory at the load control device.

18. The method of claim 16, wherein the selected preset speed and the selected possible speed are received in a single message.

19. The method of claim 15, wherein receiving the indication of the selected preset speed to configure further comprises receiving the indication of the selected preset speed in response to detecting a first actuation of a user interface of the load control device, and receiving the indication of the selected possible speed to which to set the selected preset speed further comprises receiving the indication of the selected possible speed in response to detecting a second actuation of the user interface of the load control device.

20. The method of claim 19, further comprising:
storing the configuration data in memory at the load control device.

21. The method of claim 19, further comprising:
entering an advanced programming mode prior to receiving the receiving the indication of the selected preset speed and receiving the indication of the selected possible speed.

22. The method of claim 15, wherein receiving the input indicating the selected preset speed further comprises detecting an actuation of a user interface of the load control device.

23. The method of claim 15, further comprising receiving a message comprising a command to control the motor load to the selected preset speed.

24. The method of claim 1, wherein receiving the input indicating the selected preset speed further comprises detecting an actuation via a slider selection tool using a graphical user interface displayed on a visible display.

25. The method of claim 1, wherein receiving the input indicating the selected preset speed further comprises detecting an actuation of a preset speed indicator using a graphical user interface displayed on a visible display; and
wherein receiving the indication of the selected possible speed to which to set the selected preset speed further comprises detecting release of the actuation of the preset speed indicator when the preset speed indicator is located at an indicator associated with the selected possible speed.

26. The method of claim 25, further comprising displaying indicators associated with the discrete preset speeds and indicators associated with the discrete possible speeds along a linear guide using the graphical user interface displayed on the visible display, wherein the preset speed indicator is an indicator associated with a discrete preset speed, and wherein the indicator associated with the selected possible speed is an indicator associated with the discrete possible speeds.

27. The method of claim 26, wherein, when actuated, the preset speed indicator is displayed larger than the other indicators associated with the discrete preset speeds.

28. The method of claim 25, further comprising:
limiting the ability of a user to associate the preset speed indicator with an indicator associated with a discrete possible speed; and
wherein the discrete possible speed is assigned to another one of the number of discrete preset speeds or is associated with a speed that is outside of a range of the discrete possible speeds that are available for the preset speed indicator, wherein the range is based on a number associated with the preset speed indicator, a number of the discrete possible speeds, and a number of the discrete preset speeds.

29. The method of claim 28, further comprising:
greying out the discrete possible speed to limit the ability of the user to associate the preset speed indicator with the indicator associated with the discrete possible speed.

30. The method of claim 28, wherein the selected preset speed can only be configured to be set to one discrete possible speed at a time.

31.-109. (canceled)
